(19) United States
(12) Patent Application Publication
(10) Pub. No.: US 2008/0097830 A1
(43) Pub. Date: Apr. 24, 2008

(54) SYSTEMS AND METHODS FOR INTERACTIVELY DELIVERING SELF-CONTAINED ADVERTISEMENT UNITS TO A WEB BROWSER

(75) Inventor: Peter H.I. Kim, Pasadena, CA (US)

Correspondence Address: BAKER & MCKENZIE LLP;PATENT DEPARTMENT, 2001 ROSS AVENUE, SUITE 2300, DALLAS, TX, 75201, US

(73) Assignee: INTERPOLS NETWORK INCORPORATED, Pasadena, CA (US)

(21) Appl. No.: 11/933,387

(22) Filed: Oct. 31, 2007

Related U.S. Application Data
(63) Continuation-in-part of application No. 09/665,482, filed on Sep. 20, 2000.
Application No. 09/665,482 is a continuation of application No. 60/155,071, filed on Sep. 21, 1999.
(63) Continuation-in-part of application No. 11/869,630, filed on Oct. 9, 2007.
(63) Continuation-in-part of application No. 11/747,084, filed on May 10, 2007.
(63) Continuation-in-part of application No. 11/750,872, filed on May 18, 2007.
(60) Provisional application No. 60/746,959, filed on May 10, 2006.
(60) Provisional application No. 60/747,637, filed on May 18, 2006.

(51) Int. Cl. G06Q 30/00

(52) U.S. Cl. 705/10; 705/14

(57) ABSTRACT

A system for interactive delivery of self-contained advertisement units is disclosed. The system includes a client web browser, an advertisement unit database element, and an advertisement unit server element. The client web browser is configured to render a web page having a designated location for a first self-contained advertisement unit, wherein the first self-contained advertisement unit is configured to enable user interactions and submission of user interaction data via a submit function and be rendered without the use of a plug-in application. The advertisement unit database element is configured to store a plurality of self-contained advertisement units. The advertisement unit server element is communicatively connected to the client web browser and the advertisement unit database element. The advertisement server element is configured to receive the user interaction data, dynamically process the user data to select a second self-contained advertisement unit from the plurality of self-contained advertisements, and send the second self-contained advertisement unit to the client web browser to replace the first advertisement unit in the designated location of the web page. The second self-contained advertisement unit being configured to be rendered without a plug-in application.

This application claims priority as a continuation-in-part application under 35 U.S.C §119, §120 or §365(c) to co-pending U.S. patent application Ser. No. 09/665,482, entitled “METHOD AND APPARATUS FOR DELIVERY OF TARGETED ADVERTISING AND CONTENT BASED ON USER INTERACTION WITH ONLINE QUERIES ON A WIDE AREA NETWORK,” filed on Sep. 20, 2000 (which in turn claims priority to U.S. Provisional Application No. 60/155,071 filed Sep. 21, 1999), co-pending U.S. patent application Ser. No. 11/469,630, entitled “SYSTEMS AND METHODS FOR INTEGRATING XML SYNDICATION FEEDS INTO ONLINE ADVERTISEMENT,” filed on Sep. 1, 2006 (which in turn claims priority to U.S. Provisional Application No. 60/714,382 filed Sep. 6, 2005), co-pending U.S. patent application Ser. No. 11/747,084, entitled “SYSTEMS AND METHODS FOR SELF-CHECKING AND IDENTIFYING ERRORS IN RICH-MEDIA ADVERTISEMENTS,” filed on May 10, 2007 (which in turn claims priority to U.S. Provisional Application No. 60/746,959 filed May 10, 2006), and co-pending U.S. patent application Ser. No. 11/750,872, entitled “SYSTEMS AND METHODS FOR DELIVERY OF MULTIPLE ONLINE ADVERTISING UNITS TO COMMUNICATION AND INTERACT ON THE SAME WEBPAGE,” filed on May 18, 2007 (which in turn claims priority to U.S. Provisional Application No. 60/747,637 filed May 18, 2006). The entirety of the disclosures of the above-identified applications are incorporated herein by reference as though set forth in full.

### BACKGROUND

I. Field of the Invention

The present invention relates generally to a centralized interactive advertisement serving system utilizing Internet technology, and more particularly, to aggregating content and delivering interactive marketing units (e.g., advertisements, queries, polls, etc.) and other targeted content to computer users through Web pages.

II. Background of the Invention

Traditionally, advertising campaigns have attempted to target and maximize specific consumer interactivity by designing particular types of advertisements for a specific media. While somewhat directed, such advertising campaigns are still broad based appeals to large demographic segments, with no material customization to the needs, desires, or attitudes of one specific individual. With the advent of the Internet and e-commerce, a form of directed advertising has developed. On the Internet, web advertisements frequently appear on Web pages, often in the form of a banner ad (with embedded Uniform Resource Locator (URL) links) prominently located on one or more Web pages. Since the Internet enables real-time interactivity, monitoring, and tracking, it is possible to know when a user views a Web page, selects a particular banner ad, or submits a response to a query question.

While monitoring and tracking a user's online behavior may be helpful to achieve better focus for future broadcasts of web advertisements, it does little to address the fact that many people simply ignore web ads. Because of their frequent use and often unengaging nature, most users simply ignore them. Without encouraging active user participation or presenting content that can be tailored to the interests of a user, the effectiveness and value of web advertisements is highly limited. In order to encourage user participation and elicit user interest, other systems have tried incorporating interactive online polls (e.g., online queries), syndication feeds (e.g., RSS, ATOM, etc.) and web widgets into the web advertisements. However, difficulties in establishing and managing a system of online queries and syndication feeds and with interactively serving the web widgets to the user have prevented their industry-wide acceptance.

It would thus be desirable to provide a centralized system to manage web advertisements for Web publishers in order to: collect useful data on a user's declared preferences, mimic interactivity with the user (through online queries), and allow a user to customize their online marketing experience; thus, creating an infrastructure that makes web advertising highly effective and profitable for both Web publishers and marketers.

### SUMMARY

Methods and systems for interactive delivery of self-contained advertisement units are disclosed.

In one aspect, a method for interactive delivery of advertisement units to a web browser is disclosed. A webpage is requested from an affiliate content server. The webpage is received in the web browser, wherein the webpage includes a request for a first self-contained advertisement unit. The webpage is rendered in the web browser, wherein the rendered webpage includes a designated space for advertisement units. The request for the first advertisement unit is sent to an advertisement server. The first advertisement unit is received. The first self-contained advertisement unit is rendered within the designated space for advertisement units, without the use of a plug-in application. The first self-contained advertisement unit is interacted with. The details of the interactions with the first self-contained advertisement unit is sent to the advertisement server. The second self-contained advertisement unit is selected based on the details of the interactions with the first self-contained advertisement unit. The second self-contained advertisement unit is sent to the web browser. The second self-contained advertisement unit is rendered within the designated space for advertisement units, again, without the use of a plug-in application.

In a different aspect, a system for interactive delivery of self-contained advertisement units is disclosed. The system includes a client web browser, an advertisement unit database element, and an advertisement unit server element.

The client web browser is configured to render a web page having a designated location for a first self-contained advertisement unit, wherein the first self-contained advertisement unit is configured to enable user interactions and submission of user interaction data via a submit function and be rendered without the use of a plug-in application.

The advertisement unit database element is configured to store a plurality of self-contained advertisement units. The advertisement unit server element is communicatively connected to the client web browser and the advertisement unit database element. The advertisement server element is configured to receive the user interaction data, dynamically process the user data to select a second self-contained advertisement unit from the plurality of self-contained advertisements and send the second self-contained advertisement unit to the client web browser to replace the first advertisement unit in the designated location of the web page. The second self-contained advertisement unit being configured to be rendered without a plug-in application.

### BRIEF DESCRIPTION OF THE DRAWINGS

For a more complete understanding of the principles disclosure herein, and the advantages thereof, reference is now made to the following descriptions taken in conjunction with the accompanying drawings, in which:

FIG. 1 is a block diagram illustrating the network (WAN) in which information is delivered to users in the form of Web pages containing web ad units and queries in accordance with the invention;

FIG. 2A is an illustration of a sample entertainment opinion poll;

FIG. 2B is an illustration of a sample entertainment trivia poll;

FIG. 2C is an illustration of a sample direct response poll;

FIG. 2D is an illustration of a sample profile poll;

FIG. 2E is an illustration of a sample sweepstakes trivia poll;

FIG. 2F is an illustration of a mini-survey poll;

FIG. 3A is a flowchart outlining the process of tagging and delivering targeted content to a particular user;

FIG. 3B is a flowchart outlining the process of tagging and recording a particular user's answers to a poll;

FIG. 4 is a flowchart outlining the processes that occur within the Content Provider User Interface;

FIG. 5 is a flowchart outlining the processes that occur within the Marketer User Interface;

FIG. 6 is flowchart outlining the processes that occur within the Affiliate User Interface;

FIG. 7A is an example of a counter-type widget that can be interactively delivered within a web advertisement unit, in accordance with one embodiment;

FIG. 7B is an example of a video stream or clip viewing widget that can be interactively delivered within a web advertisement unit, in accordance with one embodiment;

FIG. 7C is an example of a multi-media content widget that can be interactively delivered within a web advertisement unit, in accordance with one embodiment;

FIG. 7D is an example of a theatre ticket locator widget that can be interactively delivered within a web advertisement unit, in accordance with one embodiment;

FIG. 8A is an example of a web advertisement unit that includes rich media content (e.g., a simple online query) that allows a user to submit preferences for one or more choices, in accordance with one embodiment;

FIG. 8B is an example of a results panel widget that can be delivered to a user in response to the user's interactions with the rich media web advertisement unit of FIG. 8A, in accordance with one embodiment;

FIG. 8C is an example of a countdown panel widget that can be delivered to a user in response to the user's interactions with the rich media web advertisement unit of FIG. 8A, in accordance with one embodiment;

FIG. 8 D is an example of a ticket locator widget that can be delivered to a user in response to the user's interactions with the rich media web advertisement unit of FIG. 8A, in accordance with one embodiment;

FIG. 9A is a depiction of a widget that is embedded within an Affiliate web page, in accordance with one embodiment;

FIG. 9B is an illustration of the base code for the widget that is embedded within the Affiliate web page of FIG. 9A, in accordance with one embodiment;

FIG. 10A illustrates a rich media widget integrated within a rich media web advertisement unit and selectively delivered to a user based on his/her interactions with ad unit, in accordance with one embodiment;

FIG. 10B is an illustration of the base code for the rich media widget of FIG. 10A, in accordance with one embodiment;

FIG. 11A is an illustration of the “pre-event” configuration of a rich media widget that transitions from one configuration to another based on a timed (or metered) setting, in accordance with one embodiment;

FIG. 11B is an illustration of the “post-event” configuration of a rich media widget that transitions from one configuration to another based on a timed (or metered) setting, in accordance with one embodiment;

FIG. 12 is a diagram illustrating an example process for web advertisement units to communicate and interact with each other on the same webpage, in accordance with one embodiment;

FIG. 13A is an illustration that provides an example of how a main ad unit communicates and interacts with an auxiliary ad unit on a webpage, in accordance with one embodiment;

FIG. 13B is an illustration that provides an example of how a main ad unit communicates and interacts with an auxiliary ad unit on a webpage, in accordance with one embodiment;

FIG. 14 is a depiction of how multiple auxiliary ad units can respond to instructions received from a main ad unit, in accordance with one embodiment;

FIG. 15 is a depiction of how multiple auxiliary ad units can respond to instructions received from a main ad unit, in accordance with one embodiment;

FIG. 16 is a depiction of how multiple auxiliary ad units can respond to instructions received from a main ad unit, in accordance with one embodiment;

FIG. 17 is a diagram illustrating an example process for identifying formatting errors in an Internet advertisement, in accordance with one embodiment;

FIG. 18 is an illustration of how multiple Internet content servers can work collaboratively to deliver Internet advertising and XML-based syndication content to a client, in accordance with one embodiment of the systems and methods described herein; and

FIG. 19 is an illustration of a web browser window that includes an advertisement unit with a XML syndication feed embedded within, in accordance with one embodiment.

### DETAILED DESCRIPTION

Individuals who use the Internet are often confronted with numerous web advertisements and other information that seek their attention. Certain embodiments of the present invention deploy self-contained interactive web advertisements that appeal to and entertain Internet users, obtain their interest, encourage their responsive interaction, and collect consumer data regarding those interactions. The collected data is the basis of building meaningful psychographic profiles that are used to target advertising to specific individuals instantly or at some point later in time.

As used herein, the Internet or World Wide Web (WWW) uses a hypermedia (i.e., comprising of graphics, audio, video, plain text, hyperlinks, etc.) based system for enabling the browsing of Internet sites. As its name implies, the WWW (i.e., Internet) is comprised of many websites linked together allowing users to travel from one website to another simply by clicking on hyperlinks. To access the web, a user (i.e., client) typically runs a web browser program (e.g., FIREFOX®, NETSCAPE®, INTERNET EXPLORER®, SAFARI™, OPERA™, CAMINO®, etc.) that assists the user in navigating from among the various websites on the WWW and renders the web pages associated with those websites for viewing by the user.

Web pages are typically written in HyperText Markup Language (HTML), Dynamic HyperText Markup Language (DHTML) or Extensible HyperText Markup Language (XHTML). DHTML denotes a collection of technologies used together to create interactive and animated web sites by using a combination of a static markup language (i.e., HTML), a client-side scripting language (such as JAVASCRIPT®), a presentation definition language (i.e., CSS), and a Document Object Model. In certain embodiments, DHTML based web pages use client-side scripting to change the variables of the presentation definition language (i.e., HTML) to affect the look and function of otherwise “static” HTML page content, after the page has been fully loaded and during the rendering process.

Internet (web) advertisement content can take any form as long as it can be rendered onto a web browser or equivalent application. Examples include: static graphical banners, interactive polls/queries, interactive games, multimedia clips, streaming video, syndicated news, multimedia feeds, etc. Rich-media denotes interactive multimedia web content that includes audio, graphics, images, video and animation in addition to traditional media (text and graphics). Web ad content can be created using any programming language (e.g., HTML, DHTML, CSS, FLASH, JAVA, ACTIVE X, XML, etc.) as long as the content can be rendered on a conventional web browser. A web widget denotes a piece of executable code that is configured to be portable such that it can be copied and embedded from one web page to one or more other web pages and/or computer graphical environments (e.g., computer desktop, etc.).

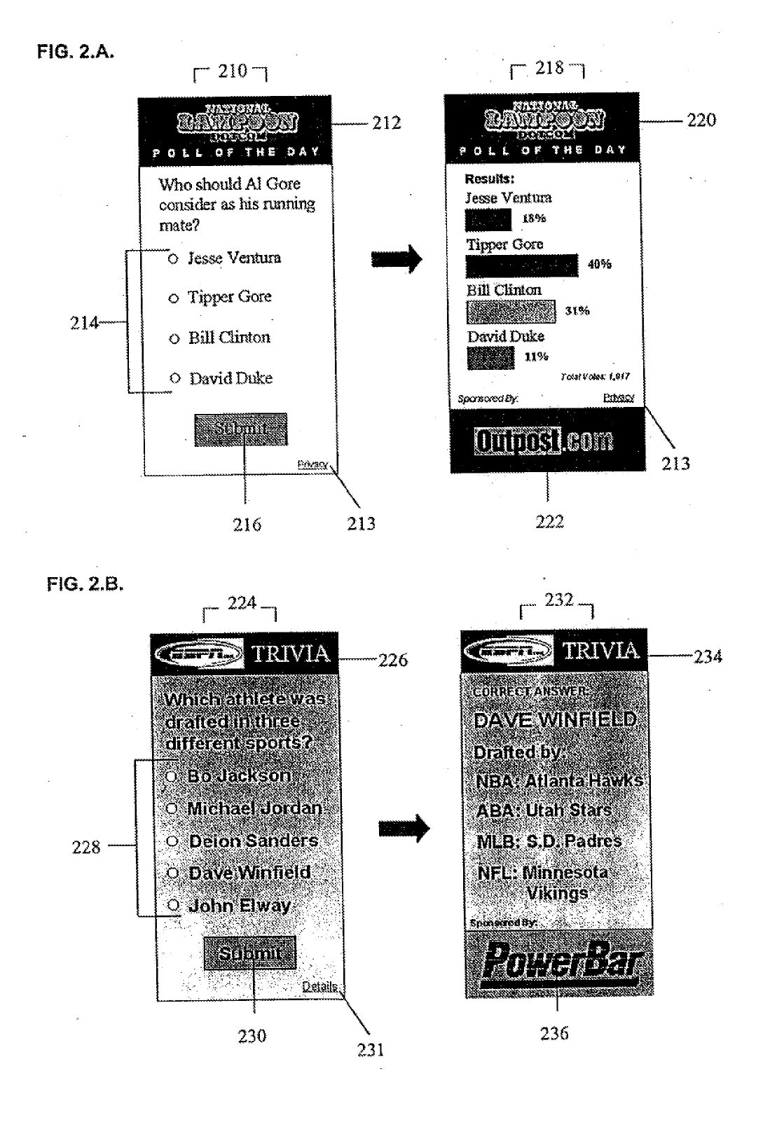

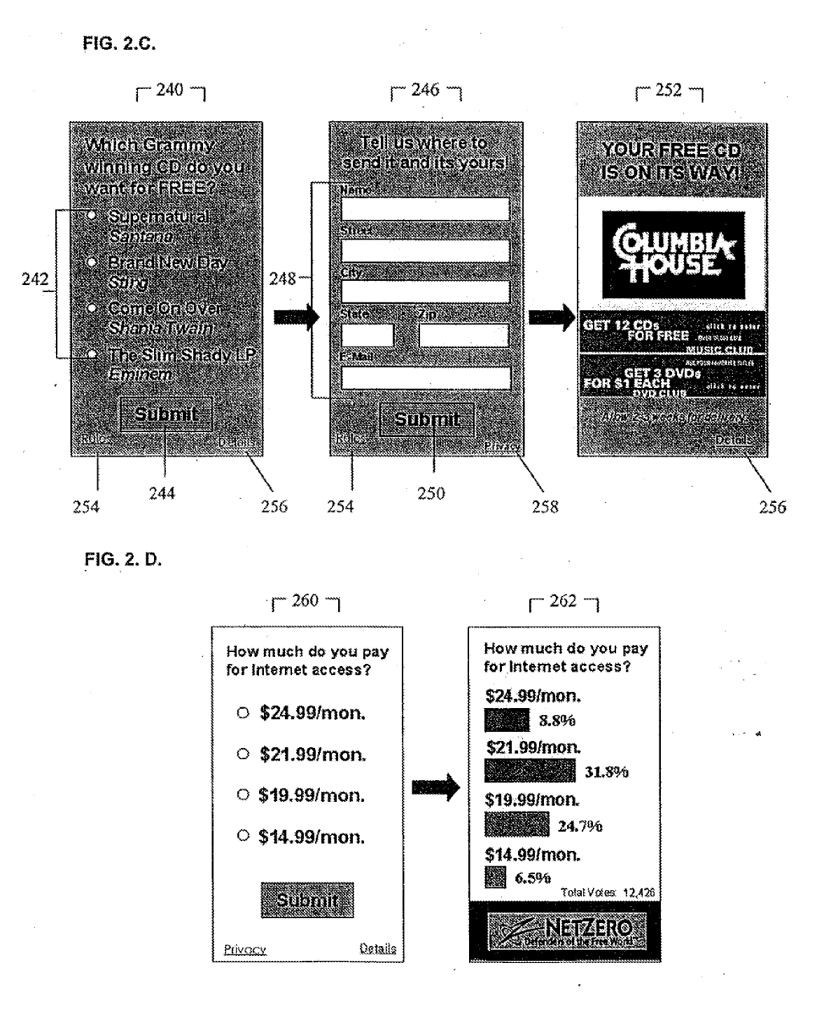

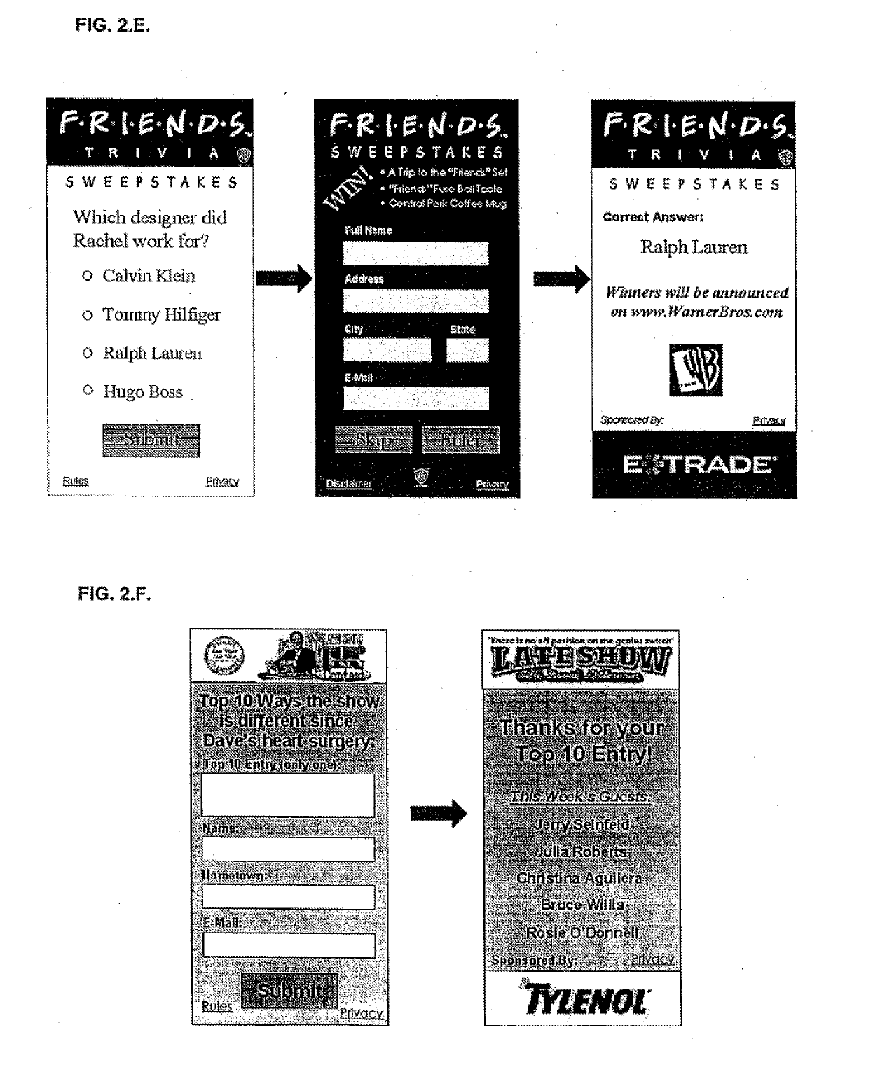

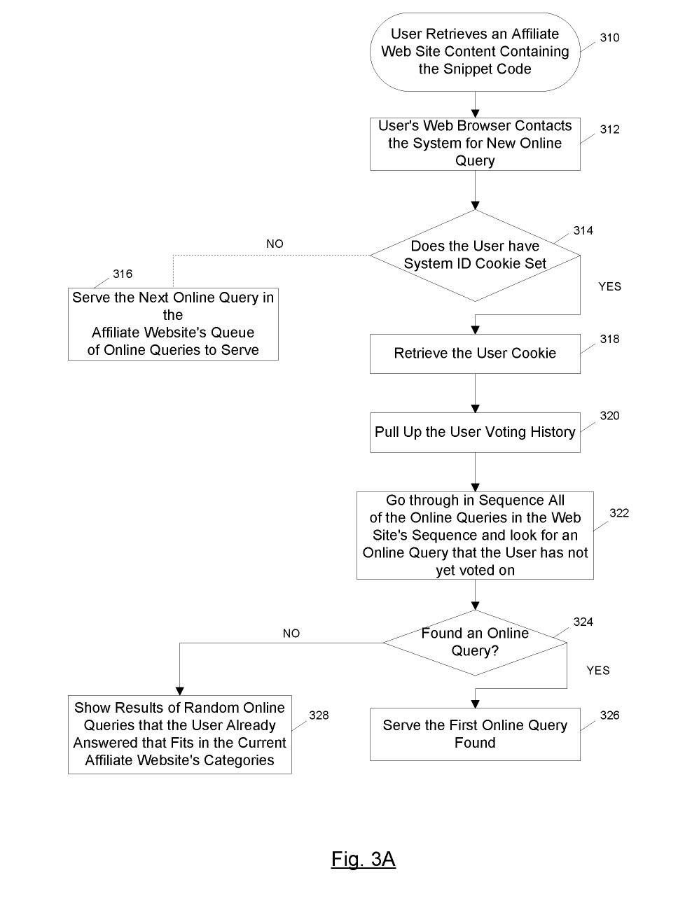

There are preferably five parties who participate in the operation of certain embodiments of the present invention. The first party includes the end-user (“Users”), namely persons who use the Internet to read and view various content existing on the World Wide Web using a conventional web browser application (e.g., FIREFOX®, NETSCAPE®, INTERNET EXPLORER®, etc). The second party can comprise of Web site affiliates (“Affiliates”) who agree to display interactive web advertising on one or more of its Web pages as selected and delivered. The third party consists of marketers, advertising agencies, sponsors, or other entities (“Marketers”) that create the marketing campaigns and web advertisement units (that can include content such as static graphical banners, interactive queries/polls, interactive games, etc.), and select the placement of the web advertisement units in order to promote specified services and goods. This group includes parties who wish to sponsor certain web ads in exchange for advertising space. The fourth party consists of news agencies, media companies, or any other businesses (“Content Providers”) that provide branded web advertisement content (e.g., graphical banners, interactive polls/queries, interactive games, etc.), as shown in FIGS. 2A and 2B, and supply the various other content (e.g., syndicated news and multimedia feeds, multimedia clips, images, streaming video, etc.) to be delivered within the web advertisement units to users. Finally, the fifth party consists of the entity that operates the advertising delivery infrastructure (“System”) that determines when and where to deliver a web advertisement unit depending on the nature of the User currently online and the marketing campaign developed by a Marketer.

In certain embodiments, the web advertisement units are configured to be self-contained. That is, the advertisement units and their content do not require 3^{rd} party plug-ins (e.g., FLASH, JAVA, ACTIVE X, etc.) to be executable on a conventional web browser. For example, web advertisement units that are created in either DHTML or CSS programming language, which are base descriptive languages that can be readily executed by any conventional web browser.

It should be noted that the Affiliates, Marketers, and Content Providers make up the clients (“Clients”) who utilize the System to reach Users. Additionally, it should be appreciated that a Client may play multiple roles. For example, a single company may serve as: (1) an Affiliate by having certain web advertisement units (such as online queries) appear on their entertainment Web pages; (2) a Marketer by developing and/or sponsoring ad campaigns to appear on other Web sites; and (3) a Content Provider by serving as a source for web advertisement content (e.g., static graphical banners, interactive polls/queries, interactive games, multimedia clips, streaming video, syndicated news, multimedia feeds, etc.). It should also be appreciated that in certain embodiments, an Affiliate may create many different types of online queries from two separate families of queries—namely, internal and external queries. As their names suggest, the internal family of online queries may contain those query questions that are created for use only in its own Web sites while the external family of online queries contain those query questions that are created for use on any Web site, including their own. Other than this distinction, no other differences exist between the internal and external family of online queries. In other words, any given online query (e.g., entertainment opinion poll, entertainment trivia, direct response poll, profile poll, sweepstakes trivia poll, mini-survey poll, etc.) may be either an internal or external online query, depending on the designation by the party that creates that specific online query. More details on the different types of online queries available via the System 120 within these two categories of queries will be provided later.

System

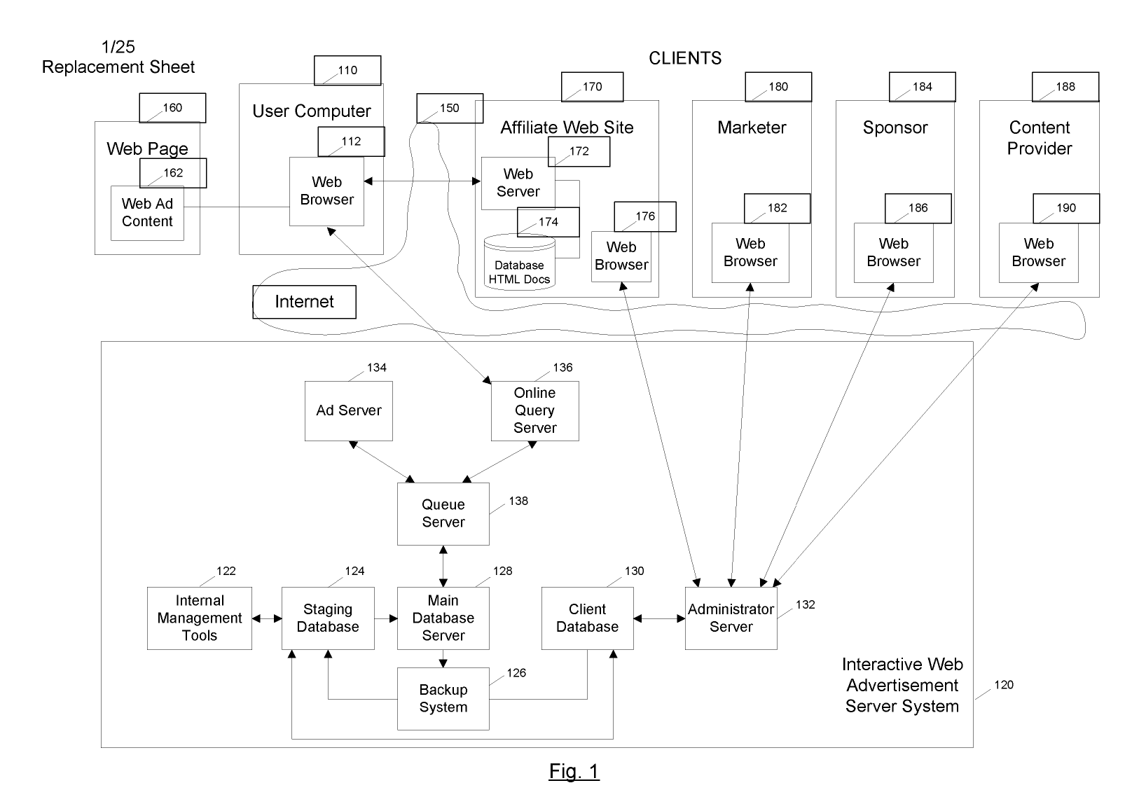

Referring now to FIG. 1, a block diagram is illustrated of a wide area network (WAN) in which information is delivered to users in the form of Web pages containing web advertisement units, in accordance with certain embodiments. It is anticipated that the present System operate with a plurality of computers which are coupled together on a communications network, such as the Internet or a WAN. FIG. 1 depicts a network that includes a user computer 110 that communicates with the System 120 and the Affiliate Web site 170 through communication links that include the Internet 150. The Affiliate 170, Marketer 180, and Content Provider 188 are also connected to the System 120 and communicate with the administrator server 132 within the System 120 through the Internet 150.

Each one of the user 110, Affiliate 170, Marketer 180, and Content Provider 188 may include any type of computing device that allows the operator to interactively browse Web sites, such as a personal computer (PC) that includes a Web browser application 112, 176, 182, 186 or 190 executing respectively thereon (e.g., FIREFOX®, NETSCAPE®, INTERNET EXPLORER®, etc). The Affiliate Web site 170 also include a Web server 172 that can selectively deliver HyperText Markup Language (HTML) documents to the user computer 110 using the HyperText Transport Protocol (HTTP). Currently, HTML 4.0 is the standard used for generating Web documents, though it should be appreciated that other coding conventions could also be used. The Web server 172 accesses a store of HTML documents 174 that can be requested, retrieved, and viewed at the user computer 110 via the Web browser 112. It should be appreciated that many different user computers may be communicating with the Web server 172 at the same time.

Within the System 120, the internal management tools 122 are what the internal staff use to manage operation of the System 120. Using the internal management tools 122, the System staff, for example, approve and classify all the content into their right categories, view Client records, and start and stop individual advertising campaigns. The internal management tools 122 are connected to a staging database server 124 which holds a copy of the live main database server 128. Since it is unstable to make live changes to the System 120, any and all changes are first made to the staging database server 124 and then replicated to the live main database server 128 in a set interval of time (e.g., every 15 minutes). The main database server 128 is the storage area for all activities of the System 120. All of the web advertisement unit content and User data are stored in the main database server 128 and is backed up all of the time in the backup system 126.

The Clients of the System 120 can communicate with the administration server 132 to manage their individual accounts within the System 120. For example, through the administration server 132, Affiliates can create or change the look and feel of their web advertisement units and Marketers can run new marketing web advertisement units. The administration server 132 is connected to the client database 130 where all Client data is stored. All Client activities are saved on the client database 130 and are stored there until the activities are approved by the System staff. Once the Client activities are approved by the System staff, that Client data is replicated to the staging database 124 which is connected to the client database 130. Within the staging database 124, the Client data is ready to be replicated to the main database server 128 in predetermined intervals (e.g., every 15 minutes). The ad server 134 and the online query server 136 are the main front end components to the Internet 150. These cluster of application servers will deliver various online queries and advertisements to the user's Web browser 112. Neither the ad server 134 nor the online query server 136 have much logic within the components, since both servers rely completely on the queue server 138 for direction.

The queue server 138 works as the “brain” behind the System 120 by communicating with the main database server 128 on one hand and the ad server 134 and online query server 136 on the other hand. The queue server 138 handles three main functions. First, it can keep track of each of the individual Affiliate Web sites and keeps a list of web advertisements and online queries ready to serve per individual Web site. Second, it can keep track of individual Users and maintains a list of targeted web ads to deliver to each User. Third, it can function as a caching server between the main database server 128 on the one hand and the ad server 134 and online query server 136 on the other hand, so that it will not be necessary to constantly read and write to the main database server 128.

Delivered Content

As generally known in the art, a user can identify a Web page that is desired to be viewed at the user computer 110 by communicating an HTTP request from the browser application 112. The HTTP request includes the Uniform Resource Locator (URL) of the desired Web page, which may correspond to an HTML document 174 stored at the Affiliate Web site 170. The HTTP request is then routed to the Web server 172 via the Internet 150. The Web server 172 then retrieves/generates the HTML document 174 identified by the URL, and communicates the HTML document across the Internet 150 to the browser application 112. The user computer 110 is then able to show the destination Web page 160 through its Web browser 112.

Unlike a conventional Web page, however, the Affiliate Web page 160 displays additional content such as web advertisement units that contain content such as online queries (e.g., polls, surveys, etc.), sponsored content, or other targeted content, referred to collectively herein as web advertisement unit content 162. It should be understood that web advertisement unit content 162 may include any one or a combination of static graphical banners, interactive polls/queries, interactive games, crossword puzzles, multimedia clips, streaming video, syndicated news, multimedia feeds, question/answer results, etc. Numerous combinations and possibilities can exist because the delivered web advertisement unit content 162 may be comprised of a plurality of panels which together make up an entire web advertisement package. For example, a simple one-question poll can have at least a question/answer panel and a results panel. An example of a more complex package of delivered content would be a question/answer panel asking the user which movie he would like to see along with the available movie choices followed by a subsequent web advertisement panel showing a streaming video of the movie.

Online query content, rendered in a web advertisement unit on the affiliate Web page 160, may appear in a simple question-and-answer type of format. Referring back to FIGS. 2A and 2B, branded online queries such as entertainment opinion 210 and trivia 224 polls seek to draw the users' attention by posing questions related to popular culture, sports, and other interesting topics. Entertainment opinion 210 and trivia 224 polls are given with multiple choice answers 214 and 228 that the user can choose within the question/answer panel. A hyperlink to a privacy statement 213 is also provided at the bottom of the question/answer panel and the results panel of the entertainment opinion 210 poll. Similarly, a hyperlink to a details page 231 is provided at the bottom of the question/answer panel of the entertainment trivia 224 poll. Clicking on these hyperlinks will pop up a new window with the privacy statement or the detailed information. Once the user makes his choice, the user can select the “Submit” button 216 and 230, respectively, to post his answer into the online query database. The Affiliate Web page 160 can refresh and the System 120 can provide the user with the results of the poll 218 and 232. In certain embodiments, the refresh operation can result in the same exact content of the Affiliate Web page 160 while replacing the online query content box (rendered in the web advertisement unit) with the results panel, product placement advertisement panel (or the next panel to be displayed within the web advertisement unit). Therefore, the Affiliate Web page 160 will receive multiple user impressions. In another embodiment, the System 120 will only replace the online query content box with the results panel (or the next panel to be displayed within the web advertisement unit) without refreshing the other contents of the Affiliate Web page 160. As the System 120 delivers the results of the online query to the user, the System 120 also incorporates delivery of appropriate web advertisement (e.g., sponsorship, etc.) information 222 and 236. In this example, Content Provider designs “creatives” 212, 220, 226, and 234 that appear above the questions and results.

Other forms of online query content may be incorporated into the web advertisement unit rendered in Affiliate Web page 160. Direct response polls 240 as seen in FIG. 2C are aimed at obtaining specific user information. As such, certain incentives such as free CD giveaways may be structured as a question to entice users to volunteer information about themselves. In this example, the user may choose the particular CD he wishes to receive from the multiple choices 242 given in the question/answer panel of the poll. Hyperlinks to the rules 254 and the details 256 of the CD-giveaway are provided at the bottom of the question/answer panel of the poll. Clicking on these hyperlinks will pop up a new window with the privacy statement or the detailed information. The user then selects the “Submit” button 244 to proceed to the next step. The Web page 160 will refresh (again, although the entire Web page will refresh, only the contents within the online query content box will change in substance) and the user will be asked to provide personal information 248 such as name, mailing address, and e-mail address within the data entry panel 246. Again hyperlinks to the rules 254 and privacy statements 258 are provided at the bottom of the data entry panel 246. Once the user enters the personal information 248 and selects the “Submit” button 250, the Web page 160 will refresh once more and the advertiser information will appear as the final display panel 252.

Profiling polls as shown in FIG. 2D are utilized to obtain direct information about the user. A profiling poll has a similar look and feel to the entertainment opinion and trivia polls and has a question/answer panel 260 and a results panel 262. Although any poll may be used to obtain information to build a particular user's psychographic profile, these profile polls are the most useful since they give specific, detailed information about the user. Other methods of gathering user information can be implemented through sweepstakes trivia polls as shown in FIG. 2E and min-survey polls as shown in FIG. 2F. These polls operate in the same manner as the other polls described above.

In operation of certain embodiments, an Internet user “surfs” from one Web page to another until he reaches an Affiliate Web page 160 containing web advertisement unit content 162. The web advertisement unit content 162 may be any one of those shown in FIG. 2A through 2D, but will usually consist of a question (query) juxtaposed with a plurality of question responses. In a preferred embodiment, a maximum of six question responses is used so as to limit the amount of space taken up on the screen. The user is encouraged to select what, in his opinion, is the appropriate response to the question posed. Users frequently interact with online queries in order to see the query results and compare themselves against other online query respondents. This unique interactivity and novel method of engaging the user is therefore utilized not only to simply conduct an online query, which is common in the prior art, but primarily to develop a psychographic profile of the user based on his answer to the query questions, and to subsequently tag that user to enable strategic web advertisement content delivery in the future. That is, details about the user's interactions with the online query and/or web ad units are dynamically processed by the ad server or online query server to select an appropriate online query and/or web ad unit to return to the user. It should be noted that the main purpose of these online queries is to start an interactive dialogue with the users, so that the users see multiple screens and interact with targeted content and advertising.

Referring back to FIG. 1, in order to deliver web advertisement unit content 162, such as online queries, within the Affiliate Web page 160, the particular HTML document 174 that is retrieved has a snippet of code written in JavaScript that instructs the Web browser application 112 of the user computer 110 to communicate with the online query server 136 of the System 120. Each snippet of code contains the Affiliate ID and information concerning the look and feel of the online query that the Affiliate has previously defined. The System 120 determines what kind of content to serve within that space designated (i.e., the web advertisement unit) on the Affiliate Web page 160. An example of the snippet of code written in JavaScript is as follows:

| | | | | | |
|---|---|---|---|---|---|
| <script | language | = | “javascript” | src | = |

“http://server.interpolls.com/onlinequery.cfm?clientid=xxxxxxxxxxxx>
</script>

It should be noted that the above example of the snippet code is for representative purposes only and that the actual snippet code may vary depending on each programming instance. In any event, the snippet code is a Client-side javascript (“CSJS”) code that requests further CSJS from the online query server 136. Therefore the user's Web browser 112 contacts the online query server 136 and the online query server 136 in turn retrieves query data, then generates a CSJS code that will display a specific online query and sends it to the user. Once the CSJS reaches the user computer 110, the user's Web browser 112 will execute the code and generate the online query.

Tagging a User

As mentioned earlier, the online interaction between the user and the online queries, delivered within web advertisement units, forms the basis on which that user's psychographic profile is developed. As such, tagging a user after that user is confronted with a Web page 160 containing web advertisement unit content 162 is critical in order to track that individual's behavior for future delivery of targeted advertising. One of ordinary skill in the art would appreciate that several methods can be used to tag the user. The user's IP address and the placement of a “cookie” on the user's machine are two ways by which a user can be tagged (i.e., identified for future use). Each method has its limitations, however. IP addresses can be shared among a number of people who use the same proxy, and therefore noting a user's IP address is not a suitable way to uniquely identify one single person. Also, users who connect through an Internet Service Provider (ISP) get a dynamically assigned IP address. Therefore, a user is most likely to have a different IP address each time he connects through an ISP.

A cookie is a piece of information that a Web site, using the user Web browser's 112 facilities, places on the hard disk drive of a user's machine for future use. Cookies are useful because they allow a Web server to store its own information about a user on the user's own computer. Typically, a cookie stores a unique number identifying a user. Thus, although cookies themselves do not usually contain a user's preferences, the unique identification number is used to access a user's particular preferences stored in the System user database. Additionally, since cookies are placed onto the user's machine and therefore can uniquely identify a single user, or more specifically, a single computer terminal, the placement of a cookie file on the user computer 110 after the user responds to a query question would be the preferred method of tagging users.

The use of cookies to identify the different users has its limitations, however. One drawback to using cookies is that some users block cookies to prevent the clutter of their hard disk drives with the placement of cookie files. Another limitation lies in the fact that to be of use, the System 120 must be able to read a user's cookie file to determine that particular user's historical interactions with query questions. Cookie files can only be read, however, by the Web site that creates them. Specifically, the Uniform Resource Locator (URL) specified in the cookie must be the same as the Web site that the user is surfing in order for the browser to send the cookie to the Web site. Therefore, in the preferred embodiment, the cookies are placed on the user computer 110 by the System 120 and not by the individual Affiliate Web site 170. Since an Affiliate web page 160 may contain information from multiple sources, as the user's Web browser 176 communicates with the System 120 to retrieve the next set of JAVASCRIPT code, the System 120 can read and place the cookie using one centralized domain name of the System 120. When it later becomes necessary to examine the user computer 110 for a tag, the online query server 136 can do so by accessing the cookie file that it placed previously.

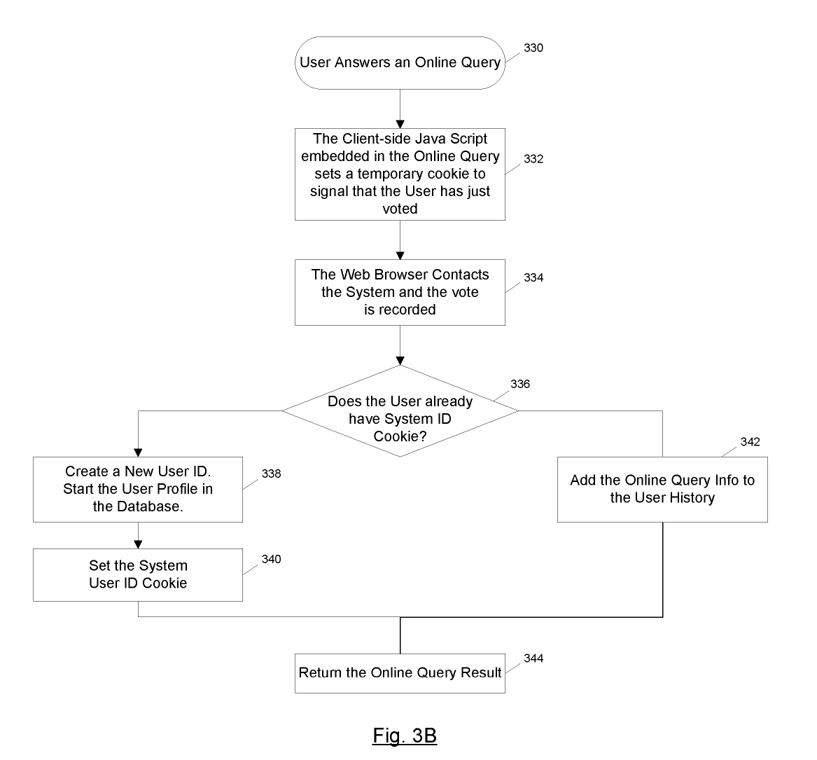

As such, referring to FIG. 3A, at step 310, when a user retrieves a specific Web page 160 (containing a web advertisement unit) of an Affiliate Web site 170, the user's Web browser 112 contacts the System 120 for a new online query (to incorporate within the web advertisement unit) at step 312. Then, at step 314, the System 120 determines whether that user has previously interacted with an online query by searching for the System User ID cookie. If the user does not have a System User ID cookie, then the System serves the next online query in the Affiliate Web site's queue of online queries to serve at step 316. In the case the user has a System User ID cookie set, then the System 120 retrieves the System User ID cookie at step 318 and pulls up the user's voting history at step 320. Next, at step 322, the System 120 goes through in sequence of all the online queries in the Affiliate Web site's sequence and looks for an online query that the user has not yet voted. If such an online query is found at step 324, then the first of such online queries found is served to the user computer 110 at step 326. Otherwise, if no such online query is found at step 324, then the System 120 proceeds to step 328 where the results of random online queries that the user has previously answered and fits in the current Affiliate Web site's categories are shown.

Referring now to FIG. 3B, once the online query is delivered to the web advertisement unit, the user interacts with the online query and answers the presented questions at step 330. Then, at step 332, the Client-side JavaScript embedded in the online query sets a temporary cookie to signal that the user has just voted. Next, at step 334, the user's Web browser 112 contacts the System 120 and the user's vote is recorded. The System 120 then determines whether the user already has a System User ID cookie at step 336. If the user does not have a System User ID cookie, the System 120 proceeds to step 338 where the new User ID and a new User Profile is created in the System database. Then at step 340 the System User ID cookie is set and the online query results are returned to the user's Web browser at step 344. If it is determined at step 336 that the user already has a System User ID cookie, the online query information is added to the user's voting history at step 342 and the online query results are returned to the user's Web browser at step 344. It should be appreciated, however, that the same sequence of steps detailed in FIGS. 3A and 3B can be utilized to interactively deliver other types of web advertisement unit content (in addition to online queries). For example, static graphical banners, interactive games, multimedia clips, streaming video, syndicated news, multimedia feeds, can all be delivered to the web advertisement unit for viewing and interactions with a user using the process described in FIGS. 3A and 3B.

Client Interface

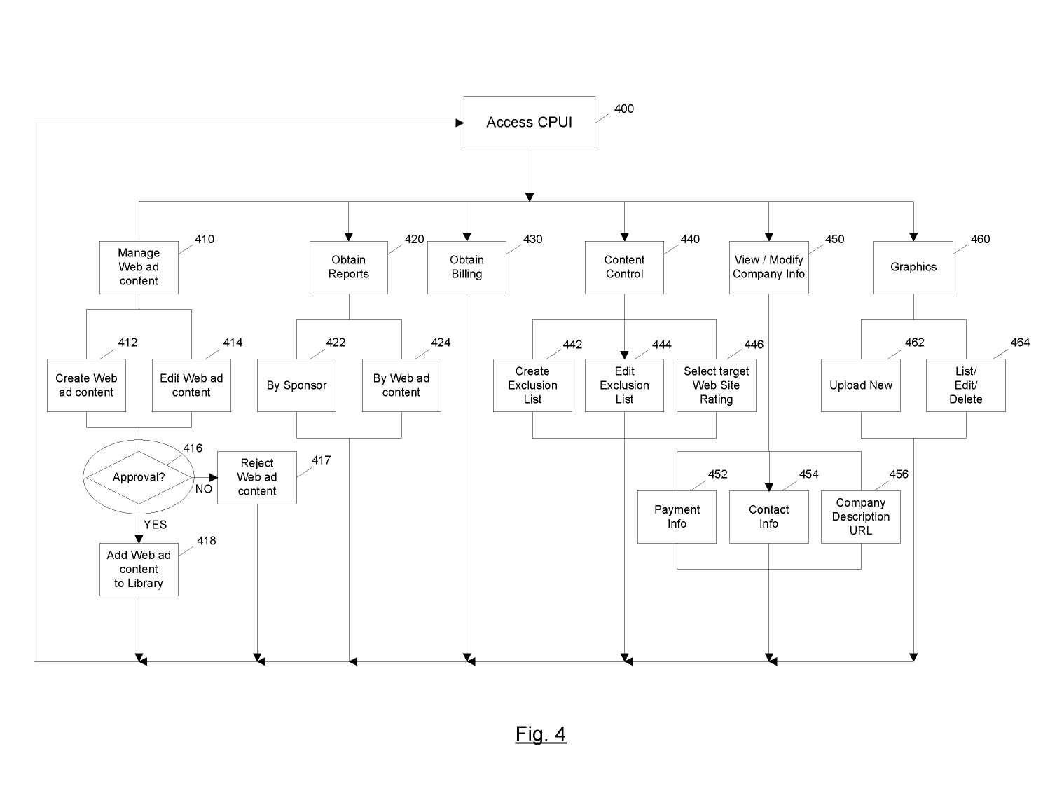

Certain embodiments of the present invention provide a forum in which Clients (i.e., Content Providers, Marketers, and Affiliates) utilize online querying technology and targeted content to effectively conduct advertising and marketing campaigns. To facilitate the interaction of these several Clients with the System 120, the preferred embodiment provides a Client Interface to enable the Content Providers, Marketers, and Affiliates to perform the necessary functions within the System 120. The different processes that occur within the present embodiment when Content Providers utilize the Content Provider User Interface (“CPUI”) are described in FIG. 4. At step 400, when the Content Providers access the CPUI via the Web browser 190 on their computer 188, the Content Providers have several options available. Using the CPUI, the Content Providers can: (1) manage their web advertisement content; (2) obtain real-time reports on their content traffic; (3) obtain latest billing information; (4) control the display of their content; (5) update account information; and (6) manage their graphics/creatives library.

If a Content Provider selects the option of managing their web advertisement content (e.g., static graphical banners, interactive polls/queries, interactive games, multimedia clips, streaming video, syndicated news, multimedia feeds, etc.), the System 120 proceeds to step 410. If the Content Provider wishes to create new web advertisement content, the System will proceed to step 412 to create the new web advertisement content. At step 412, Content Providers are required to categorize and define the content rating for the web advertisement content that they create. On the other hand, if the Content Provider desires to edit previously created web advertisement content, then the System 120 will proceed to step 414. Here at step 414, only the simplest modifications are allowed. If the web advertisement content changes are too drastic, the Content Provider will need to create 412 new web advertisement content. Spelling errors or slight wording changes are situations in which modification of that web advertisement content is possible. However, Content Providers can neither delete a part (i.e., an answer choice of an online query) of the web advertisement content nor substantively change it in any way because such changes may impact the results from a user's interactions with the web advertisement content (example: tainting present voting record for that online query). Once the Content Provider has finished either creating or modifying a particular web advertisement content, it is submitted for approval at step 416 to ensure that every piece of the created content is appropriate and categorized correctly. If the web advertisement content fails to meet the required criteria, the web advertisement content is rejected at step 417 and the Content Provider is led back to the CPUI at step 400. If the web advertisement content does meet the required criteria, then the web advertisement content is placed into the System Content Provider web advertisement content library within the database 130 and the Content Provider is led back to the CPUI at step 400. With such a strict approval process and organizational structure, the System Content Provider web advertisement content library serves as an invaluable tool at a later time, since potential sponsors search this library for the appropriate set of web advertisement content to sponsor.

Content Providers may also choose to receive real-time reports on their content traffic through the use of the CPUI. Upon the Content Provider's selection of this option, the System 120 proceeds to step 420 where the System 120 will provide reports on how the Content Provider's web advertisement content are performing and generating revenue. The data will display and analyze the web ad content, sponsors, Web sites, responses, and Users. If the Content Provider selects a particular sponsor and a specific date range, the System 120 can proceed to step 422 and furnish various types of reports. For example: (i) number of impressions per web advertisement content (e.g., online query, etc.); (ii) number of interactions per web advertisement content (e.g., number of responses per online query, etc.); (iii) response yield percentage per web advertisement content (e.g., online query, etc.); (iv) total number of web ad content (e.g., online query, etc.) impressions; (v) total number of responses; (vi) total response yield percentage; (vii) number of responses per online query answer choice; (viii) response yield percentage per online query answer choice; (ix) volunteered information such as answers to a specific question, mailing address, email address; (x) the different Web sites to which the web advertisement content were delivered; and (xi) the categories of the different Web sites to which the web advertisement content were delivered. Affiliate Web sites that display the various web advertisement content are grouped into a plurality of different categories. In the preferred embodiment, for example, the categories are: (1) Autos; (2) Business and Finance; (3) E-Commerce and Shopping; (4) Entertainment; (5) Teens; (6) Women; (7) Health; (8) Home and Health; (9) Internet and Technology; (10) Web Related Services; (11) Lifestyle & Fashion; (12) Music; (13) News and Media; (14) Sports; (15) Travel & Weather; (16) Portal and Communities; and (17) Politics. All of the Affiliate Web Sites are required to select the category that best describes the content and user interest related to their Web site during the registration process. Below these main categories, there will also be sub-categories available to more accurately describe the various Web sites as the network of affiliates grows. The categorization process is used for Content Providers and Marketers to determine which Web sites should display their advertisement campaigns.

If the Content Provider selects a particular web advertisement content and a specific date range, the System 120 can proceed to step 424 and may furnish any of the following type of reports: (i) number of impressions delivered; (ii) number of responses; (iii) number of responses per answer (when the web advertisement is an online query); (iv) response yield percentage; (v) response yield percentage per answer choice (when the web advertisement is an online query); (vi) list of sponsors; (vii) number of responses per sponsor; (viii) number of responses per answer choice per sponsor (when the web advertisement is an online query); (ix) response yield percentage per sponsor; and (x) response yield percentage per answer choice per sponsor (when the web advertisement is an online query). These reports enable the Content Providers to view which web advertisement content are popular and which are not, thus allowing the Content Providers to adjust their new content accordingly.

Content Providers may also receive the latest billing information through the CPUI. At step 430, the System 120 provides Content Providers with information concerning how much revenue they have earned from past and current periods, as well as other account and billing information. When the Content Provider selects a particular sponsor and a specific date range 432, the System 120 can provide the following types of reports: (i) revenue calculated per sponsor per marketing campaign; and (ii) dollar amount representing the total number of online query responses by sponsored online query multiplied by the unit revenue per response.

There are other options available for Content Providers through the CPUI. If Content Providers choose to establish content control—decide as to what type of Web sites are able to host and display their content (“target Web sites”), the System 120 will proceed to step 440. As mentioned previously, in the preferred embodiment, Content Providers display their web advertisement content on their own Web pages as well as on the Affiliate Web pages. Thus, it is important for the Content Providers to have control over which Affiliates host and display their web advertisement content. There will be instances where Content Providers will not want their branded content being displayed at certain types of Web sites because of the content contained in those Web sites. For example, a movie studio that provides entertainment trivia polls may not wish that their logo, trademark, or other associated advertising material appear on adult-oriented Web sites. In order to facilitate this control, the System 120 at step 440 provides Content Providers with several content control choices. Upon choosing, a Content Provider may, at step 442, create a list (i.e., exclusion list) of Affiliate Web sites which should be excluded from hosting and displaying that Content Provider's web advertisement content and sponsored advertisements. In addition, the Content Provider may, at step 444, edit their pre-existing exclusion list.

The Content Providers can also select which Affiliates will display their web advertisement content and sponsored advertisements by setting a “Content Rating” range of target Web sites. In the preferred embodiment, all Affiliates are required to rate both the content and appropriate audience for the material appearing on their Web pages through an established Content Rating guideline (i.e., Rated G, PG-13, R, etc.). Thus, the System 120 allows Content Providers another option in addition to the direct exclusion lists to monitor which Affiliate Web sites will host and display their web advertisement content. If Content Providers select to establish the Content Rating range of the target Web sites, the System 120 will proceed to step 446 where the System 120 allows Content Providers to establish the minimum and maximum Content Rating levels for its target Web sites.

It should be noted that in the preferred embodiment, each time a new Web site joins the Affiliate network, that new Affiliate will submit the content of its Web site, its content rating, and category to the System staff for review. Although the default setting in the present embodiment is to automatically include all new Affiliates (pending that the content of the Affiliate's Web site falls into the appropriate content rating requirements) to host the applicable Content Provider web advertisement content, the Content Providers may access the CPUI to turn off this default option. In the event a Content Provider chooses to turn off this default option, that Content Provider must then examine the list of new Affiliates and approve the list for content serving.

The System 120 also provides Content Providers the option of updating any of their company information. If the Content Providers wish to modify their company information, the System 120 proceeds to step 450. From this point, the System allows Content Providers to update their contact information at step 454, update payment method/information at step 452, and update company description/URL at step 456. Within the CPUI, Content Providers may also create new and modify pre-existing designs (“creatives”) that exist in their library of logos. If the Content Providers choose to make new designs or modifications, the System 120 proceeds to step 460. Upon the Content Provider's choice, the System 120 will proceed to step 462 to create new designs and upload them to the logo library or proceed to step 464 to add/remove old creatives. However, before the creatives are permanently saved to the logo library, the creatives must be approved by the System staff.

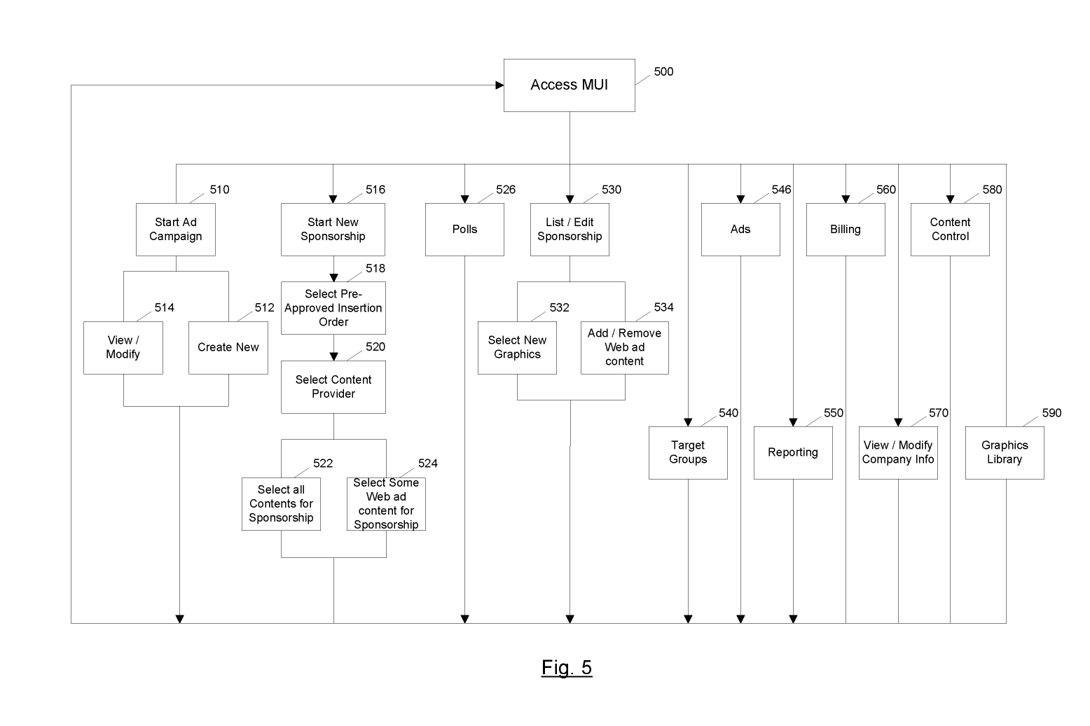

Referring to FIG. 5, the different processes that occur within the present embodiment as Marketers access the Marketer User Interface (“MUI”) are described. At step 500, through the MUI, the System 120 allows Marketers to: (1) start new marketing campaigns; (2) start new sponsorships; (3) manage their web advertisement content; (4) edit sponsorship content; (5) manage target groups; (6) manage the advertisement library; (7) obtain real-time reports of their web advertisement content and ads displayed; (8) obtain real-time billing information; (9) establish content control; (10) update account information; (11) and manage their graphics/creative library. If the Marketer selects to create/start a campaign, the System 120 will proceed to step 510 at which point the Marketer will have the option of creating a new campaign or viewing/modifying a previously created campaign. If the Marketer decides to create a new campaign, arrangements must first be structured offline. Once the offline arrangements have been made, the Marketer can select the create new campaign option and the System then proceeds to step 612 and requests the Marketer to submit an insertion order (IO). An insertion order is a legally binding document that defines the terms of the campaign. When a Marketer initiates their campaign with the System 120, they must first select the pre-approved (IO) campaign, then use the campaign creation tool/interface (explained later below) to define the details of the campaign. The campaign settings (i.e., web advertisement content, category, Web sites, etc.) must be approved by the System staff before it is cached into the database 130. A Marketer will be able to modify a campaign at step 514 as long as the changes fall within the parameters of the original IO. Modifications will also need approval by the System staff before being implemented. Marketers may add/subtract web advertisement content, target groups, and ads.

To start a sponsorship, the arrangements must again be first structured offline. Once the offline arrangement have been made, marketers must choose the sponsorship option and proceed to step 516. The System 120 will then require the sponsors to submit an IO at step 518 before they can start a sponsorship campaign. When an IO is approved, the sponsors can then select the IO and choose the web advertisement content or Content Provider that they would like to sponsor based on the IO terms at step 520. The System 120 will proceed to step 522 if the sponsor decides to sponsor all of the Content Provider's content or proceed to step 524 if the sponsor decides to sponsor specific selected web advertisement content. After the sponsor submits the request, the System staff is notified to obtain approval and authorization of the sponsorship between the sponsor and Content Provider.

If a Marketer selects to create new web advertisement content or modify pre-existing ones, the System 120 proceeds to step 526. As mentioned previously, there is a strict approval process in the creation of and modification of web advertisement content. The System staff must approve the online query (i.e., content, rating, category, etc.) before it is saved into their web advertisement content library. Once web advertisement content is created, only the simplest modifications are allowed. Only specific aspects of the web advertisement content can be modified without adversely affecting the integrity and results of that web advertisement content (e.g., cannot change or delete choices of a live online query, since past results screen and data will not match). If the web advertisement content changes are too drastic, the Marketers will need to create a new web advertisement content. Spelling errors or slight wording changes are acceptable modifications. In any event, the System staff must review all activities of web advertisement content creation and modification in order to ensure that the web advertisement content is appropriate and that each web advertisement content is categorized correctly.

In case a Marketer selects to modify any sponsorship campaigns, the System 120 proceeds to step 530. There are only two modifications that a sponsor can make once a campaign has begun. Sponsors can either remove/upload a new logo creative that is attached to a particular web advertisement content's sponsor section at step 532 or add/remove sponsorship content from the Content Provider's web advertisement content list at step 534. Depending on how the sponsor selected the web advertisement content to sponsor, it will affect how the System 120 processes new content that is later added by a Content Provider. If the sponsor selected to sponsor all of the web advertisement content from a particular Content Provider, then any new content added by the Content Provider will be automatically accepted and sponsored. However, if only specific web advertisement content were selected, new content will not be automatically accepted and sponsored. The sponsor will have to continue to select specific web advertisement content—whether new or old—to sponsor those web advertisement content.

In order to run an effective marketing campaign, it is imperative that Marketers be able to pinpoint the target audience to whom specific advertisements will be directed. Thus, at step 540, Marketers may use the MUI to create target groups—an arbitrary list of users who have responded to online queries (as discussed previously, a type of web advertisement content) and are created for targeting purposes. Marketers create target groups by selecting the online query questions and the possible response combinations for the group of Users the Marketers wish to target. Once the target groups have been created and named, they can be used for targeting any online query/web ad campaign. For example, a Marketer can make a target group called “Users Who Invest Online” by selecting the question/answer combination of: Question—“Do you invest online?” and Answer—“Yes or No”. All of the respondents to this online query question and specific response will be the target group that receives future web advertisement content from the advertiser as related to online investing options. The System staff will also be able to create target groups internally. In this manner, high quality target groups classified into different categories will be available for all Clients. The System staff will have access to all the profiles and will be able to eliminate clutter and identify the more valuable profiles for Marketers to target.

Marketers may also manage their ad library using the MUI. Upon the Marketer's selection of this option, the System 120 proceeds to step 546. This function allows the advertiser to upload web advertisements into their own library. Once the ad is uploaded, the System staff must approve the web advertisement content before it is cached in the database 130. All ad banners will be rated in order to match Web site interests and requirements. After the web advertisement content has been loaded into the library and approved, it is ready for use in any marketing campaign.

Other options available for Marketers through the MUI include obtaining real-time reporting of web advertisement content displayed 550, obtaining real-time billing information 560, updating company information 570, establishing content controls 580, managing the graphics/creative library 590. Since these functions operate in the same manner as described above for Content Providers, the details of their operation will not be repeated here.

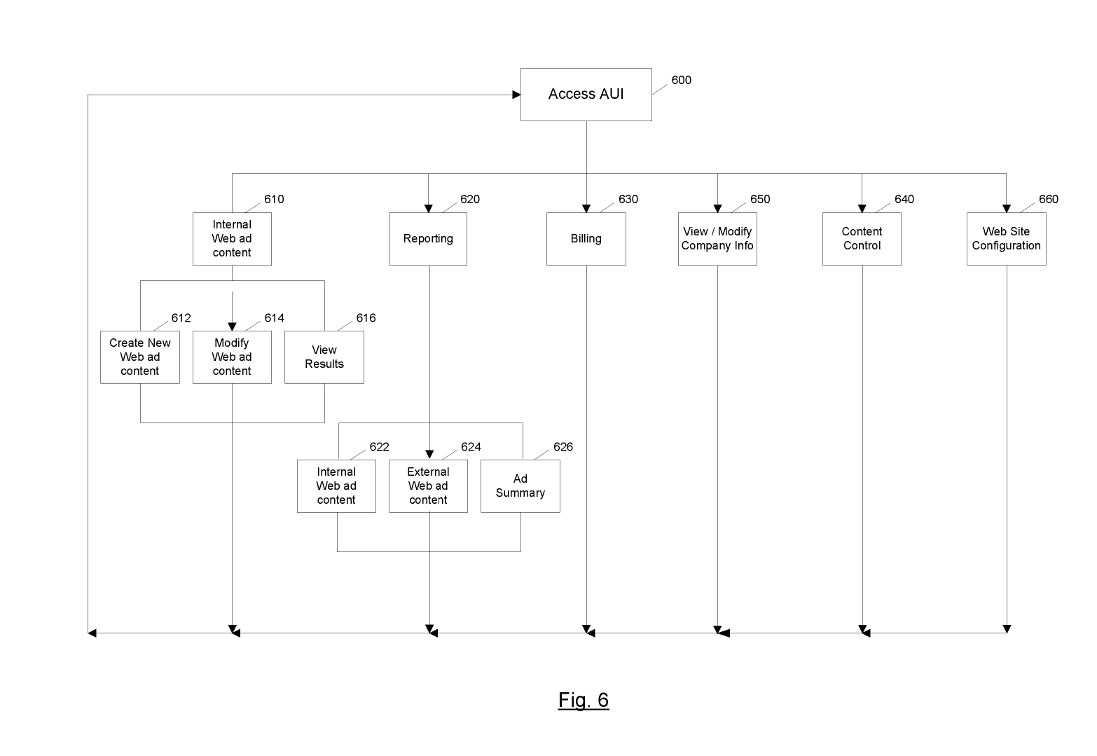

The current advertising approach becomes more effective when more Web sites become Affiliates to the System 120. In order to attract numerous Web sites to join the network of Affiliates and use the System 120, the System 120 provides the Affiliates with the right tools and technology to host web advertisement content that generate revenues on a per-response basis. To better understand the tools available for Affiliates, the different processes that occur within the present embodiment as Affiliates access the Affiliate User Interface (“AUI”) are described in FIG. 6. At step 600, through the AUI, the System 120 allows Affiliates to: (1) either create and display their own internal web advertisement content; (2) generate revenue through the display of external web advertisement content made by Content Providers, Marketers, or sponsors; (3) configure their Web site; (4) obtain real-time reports on their content traffic; (5) obtain the latest billing information; (6) monitor what types of web advertisement content may appear on their Web pages; and (7) update its account information.

If Affiliates select to create new internal web advertisement content within the AUI, the System 120 proceeds to step 610. From step 610, the Affiliate may create new web advertisement content at step 612, modify existing web advertisement content at step 614, or view the results of user interactions with their internal web advertisement content (e.g., statistics related to answers to online queries, etc.) at step 616. The Affiliate User Interface 600 (“AUI”) is unique in that unlike any other user interface, the AUI allows the Affiliates to modify their internal web advertisement content at step 614 whenever and however they like. Unlike external web advertisement content, internal web advertisement content may be changed in any manner upon the Affiliate's choosing. Affiliates may even implement changes that taint the tally results of the web advertisement content responses since it is internal web advertisement content and the decision is solely on that Affiliate. Thus, Affiliates can rephrase and add/delete specific segments of the web advertisement content (e.g., online query response choices, etc.).

Since Affiliates will most likely be concerned with the web advertisement content aesthetically matching and blending with the rest of the content on their site, the System 120 will allow Affiliates to enter all of the necessary parameters needed to achieve the right look. Specifically, the Affiliates can control the border, background, fonts, sizes, colors for every part of the web advertisement content—header, question, responses, disclaimers, privacy, and graphical sections. The Affiliates can also set the default disclaimers for terms of use, privacy, or other rules or have links to Web pages displaying the disclosures that they need to provide users. All of these features will be available in the affiliate user interface (AUI) described below. The System 120 will also provide Affiliates with a preview opportunity to view their web advertisement content before submission into the database 130. However, even the Affiliates will not be allowed to implement changes to web advertisement content that would adversely affect the integrity and results of that web advertisement content (e.g., cannot change or delete choices of a live online query, since past results screen and data will not match).

The AUI also enables Affiliates to obtain real-time reports on their content traffic. The reporting section 620 will report various aspects of web advertisement activity and ad delivery on their Web site. Affiliates will be able to view real-time reporting on internal web advertisement content 622, external web advertisement content 624, and web advertisement performance 626 displayed throughout their site. The AUI provides another important feature by providing Affiliates the ability to place the necessary snippet code in their HTML document to display the appropriate web advertisement content. When an Affiliate decides to place web advertisement content 162 in their Web page 160, the Affiliate must install a HTML code into the Web page 160 at step 660.

Similar to the functions of the other user interfaces, the AUI provides Affiliates with the tools for obtaining the latest billing information at step 630 to keep track of the amount of revenue earned from external web advertisement content and ad delivery, for establishing content controls at step 640 to monitor which types of sponsors and advertisements are displayed on its Web pages, and for updating its account information at step 650. Since Affiliate Web sites will have an interest in monitoring what types of web advertisement content may appear on their Web pages, the System 120 will require Content Providers to rate both the content and the appropriate audience for all of its web advertisement content through the previously mentioned Content Rating system. As such, the System 120 at step 640 will allow Affiliates to establish the Content Rating range such that only those materials that fall within that predetermined minimum and maximum range may appear on their Web pages.

Campaign Creation Tool/Interface

In order to create the marketing campaign, Marketers (and Content Providers for the purposes of generating branded content polls) are provided the options of creating, modifying, deleting, and viewing a campaign. To do so, a Marketer accesses a marketing campaign management tool accessible via the Internet to Marketers who register and create personal accounts. Once in the marketing campaign management tool, the Marketer can choose to create a marketing campaign. The Marketer is then presented with three options of creating: (1) a web advertisement campaign; (2) an online query campaign; or (3) a campaign having a combination of both online queries and web advertisements.

An web advertisement campaign is created by having the Marketer define for the campaign: (1) a title; (2) a start date; (3) an end date; and (4) a set of advertisements and selecting an order, weight, or other selection parameter to each ad and a target group to whom each ad should be delivered or other target criteria, such as a particular type of Web site. An online query campaign is created by having the Marketer define for the campaign: (1) a title; (2) a start date; (3) an end date; and (4) an online query question having up to six possible query responses, and selecting a target group to whom each online query should be delivered or other target criteria, such as a particular type of Web site. Depending on the type of online queries used in the online query campaign additional parameters need to be defined, such as specific answers to a trivia poll question or topics of a mini-survey. An online query campaign integrated with advertisements is created by having the Marketer create for the campaign: (1) a title; (2) a start date; (3) an end date; and (4) a query question having up to six possible query question responses, and assigning the paring of advertisements to certain query question responses and selecting an order, weight or other selection parameter to each ad, and a target group to whom each ad should be delivered or other target criteria, such as a particular Web site type.

Revenue Model

In a further embodiment, a novel revenue model is incorporated to encourage many Web sites to become Affiliates. As discussed, the System can deliver web ad units to Affiliate Web sites. Such web ad units can be designed by Marketers who will be able to include ad content in the form of an online query having a question and up to six possible responses. The online query is designed to appeal to and elicit answers from potential buyers of a particular product or service (i.e., potential qualified leads). Once a user responds to an online query by submitting a response, the user becomes a “qualified lead”. For enabling the generation of this qualified lead, the Marketer will pay a fee for each lead generated. Affiliates who received and displayed the online query question that generated the lead will receive a portion of that fee. Therefore, in an example where the cost of a lead is $1.00, paid by the Marketer, an Affiliate could earn $0.25 every time it generates such a lead by exposing each of its Web site viewers to an online query and having each viewer answer that online query. Content providers will also share in the stream of revenues when Marketers use branded online query content in their campaigns. In short, Affiliates are provided with diverse online queries and sticky content (branded content, direct response—marketing related, profile related, entertainment/trivia, etc.), and pays them for each response.

When the qualified lead surfs to another Affiliate Web site, a targeted advertisement based on their previous online query responses (i.e., declared preferences), will be delivered to that user. Marketers are able to associate up to five different web ads per set of declared preferences and are able to provide criteria that will determine which ad should be delivered to a given qualified lead. For delivering a web ad to a qualified lead, the Marketer will pay a fee. The Affiliate that displayed the delivered web ad will receive a portion of that fee and the Affiliate that first generated the qualified lead by displaying the online query will also receive a portion of that fee (a residual referral fee). For example, where the cost of delivering a web ad to a qualified lead is $0.50, the Affiliate Web site receiving and displaying the web ad may receive $0.25, and the Affiliate Web site that first generated the lead by displaying the online query may receive $0.10. It should be appreciated that other revenue models could be used in combination with the online query and web ad delivery system and marketer campaign management system. The example provided above is just one illustration of how the pricing may be set and the actual prices may vary from one Client to another.

It should be noted that the interaction with online queries creates ideal opportunities for a performance-based pricing model (i.e., charging per response). With banner ads and other forms of online web advertisements, performance-based pricing occurs on a “click-through” basis. Most Web publishers oppose this pricing model since advertisers often receive “free” exposure of the ads or brands when user click-throughs do not occur. Online queries are the perfect solution to this problem, since online queries may be tailored so that only the online query question and its answer choices are initially displayed, without web ads or advertisers' brands being shown. The advertisers have an opportunity to display their message only after a user responds to the online query question. Therefore, advertisers get charged every time their message or brands get exposure and the Web publishers no longer face the “free” exposure problem.

Modification of User Profiles

In a yet another embodiment, Users are given the opportunity to modify their own profile characteristics. Users are encouraged to refine and extend their profiles so that targeted content delivered to each user will be more relevant and useful. Users may access a Web site dedicated to viewing, modifying, deleting, or adding online query responses that best describe and fit their interests and preferences. When a user accesses this Web site, they are presented with a very typical portal interface. If the user has a System User ID cookie in their Web browser 112, then the System 120 will read the cookie, identify the specific user, and present the user's personal profile. That user will then be able to look at past online queries that he previously answered and can change those preference if desired. The System 120 will also present the user with an option to browse through previously unanswered online queries and ask the user to answer those online queries if desired. Thus, the System 120 will enable users to control the content of their web ads and online queries delivered to them within the network of Affiliate Web sites.

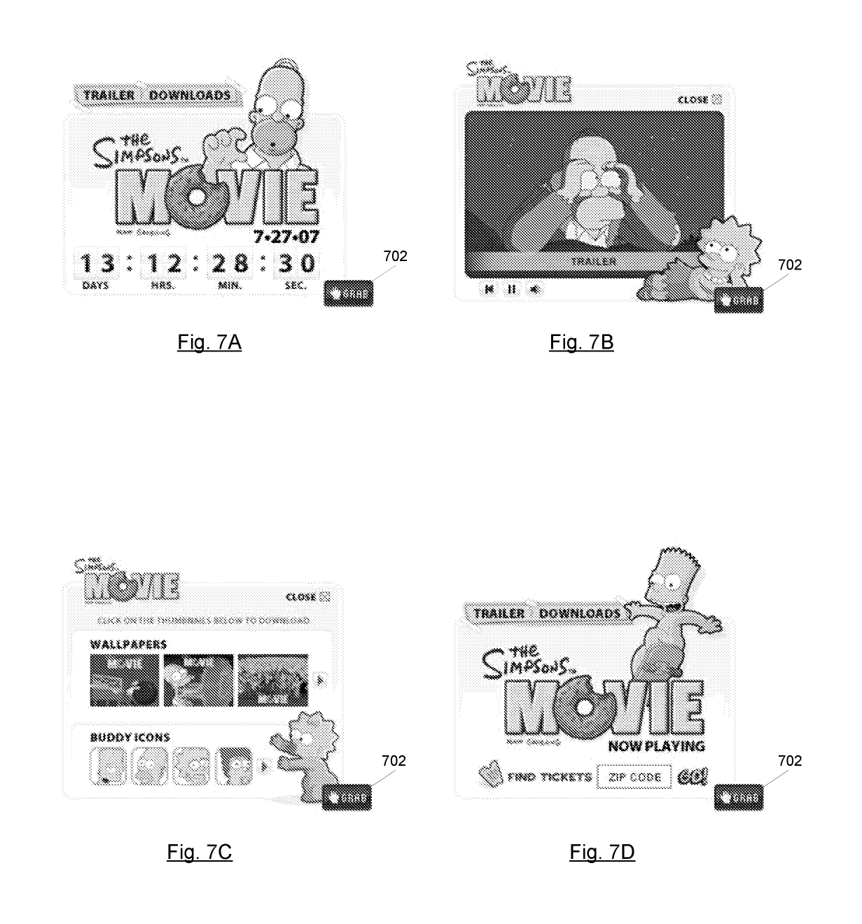

FIGS. 7A-7D are examples of the various types of widgets that can be interactively delivered within web advertisement units, in accordance with certain embodiments. As discussed previously, widgets are pieces of executable code that are configured to be portable such that they can be copied and embedded from one web page to one or more other web pages and/or computer graphical environments (e.g., computer desktop, etc.). Typically, widgets are configured such that they can be installed and executed within any separate HTML-based web page by a user. Examples of different programming languages that can be used to create widgets includes, but are not limited to: HTML, JAVASCRIPT®, and FLASH. It should be appreciated, however, that widgets can essentially be created using any programming language as long as it is portable and can be executed in a web page using a conventional web browser application.

Widgets can be configured to have various static (e.g., branding banners, hyperlinks, etc.), multimedia (e.g., video clips, audio clips, etc.), syndicated content (e.g., XML feeds, RSS feeds, etc.) and/or interactive features (e.g., online queries, polls, games, etc.) that can enhance a user's personal social network page (e.g., MYSPACE®, FACEBOOK®, LINKEDIN®, FRIENDSTER®, etc.) and/or personal home page. For example: FIG. 7B is a widget configured to play a movie clip, FIG. 7C is a widget configured to allow a user to download various multi-media content (i.e., wallpapers and buddy icons), and FIG. 7D is a widget configured to allow users to enter a zip code to locate THE SIMPSONS MOVIE tickets in theatres within the entered zip code.

In one embodiment, the widgets are configured to be served within standalone web advertisement units. For example, FIG. 7A is a depiction of a countdown widget that can be directly delivered to a web browser when it requests a web page from a web site associated with that web advertisement unit. Once delivered to the web browser, the user can choose to “Grab” 702 (i.e., copy the widget code segment) by simply clicking on the “Grab” 702 button on the ad unit to reveal the underlying code for the widget and copying/pasting that code into the user's personal social network page and/or personal homepage.

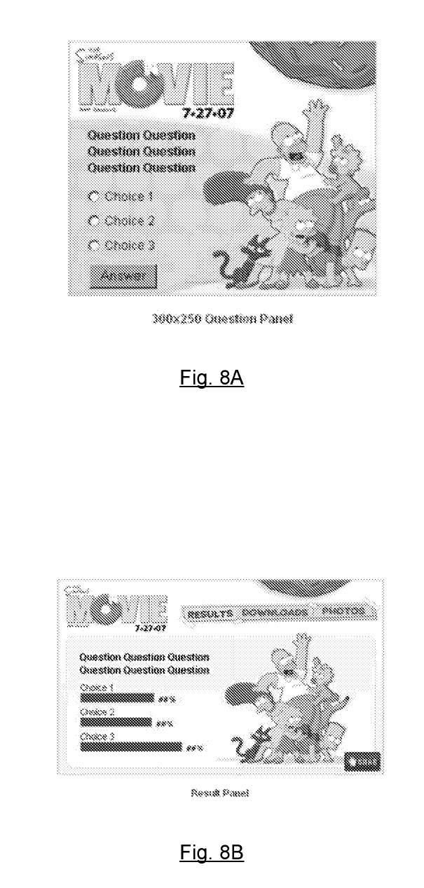

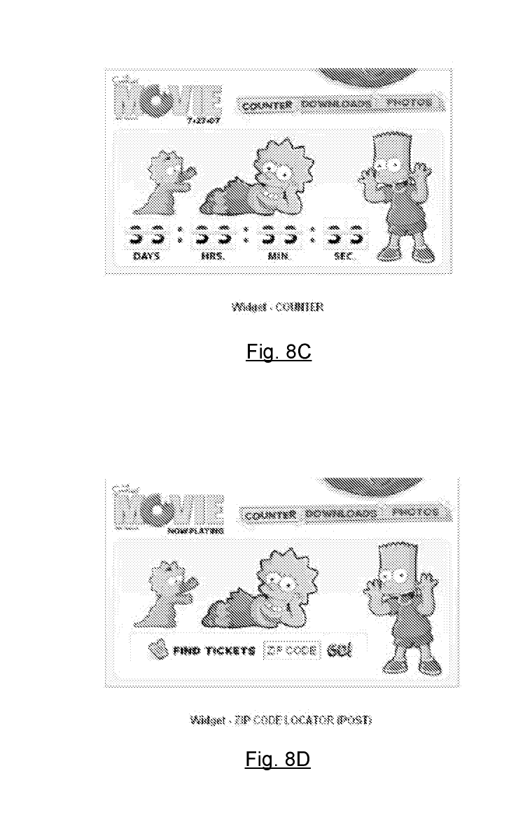

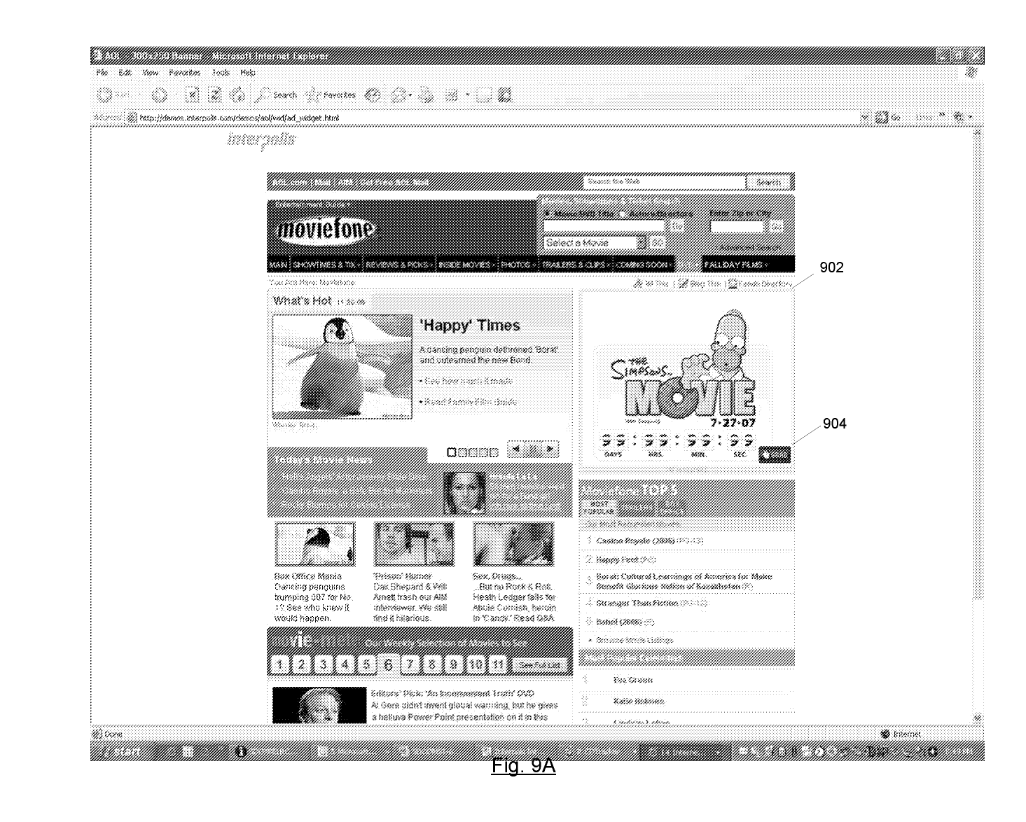

In another embodiment, widgets can be integrated with regular or rich media web advertisement units and selectively delivered (syndicated) to users based on their interactions with rich media content rendered on the same web advertisement unit (e.g., responses to online queries, polls, trivia questions, etc.). For example, FIG. 8A is a web advertisement unit that includes rich media content (e.g., a simple online query) that allows a user to submit preferences for one or more choices. When the user submits a choice (i.e., choice 1), that information is communicated to the ad server(s) (i.e., Interactive Web Advertisement Server System 120) which then selectively returns a web advertisement unit containing the appropriate widget (e.g., FIG. 8B: Results Panel Widget, FIG. 8C: Countdown Panel Widget, and FIG. 8D: Ticket Locater Widget) based on those interactions.

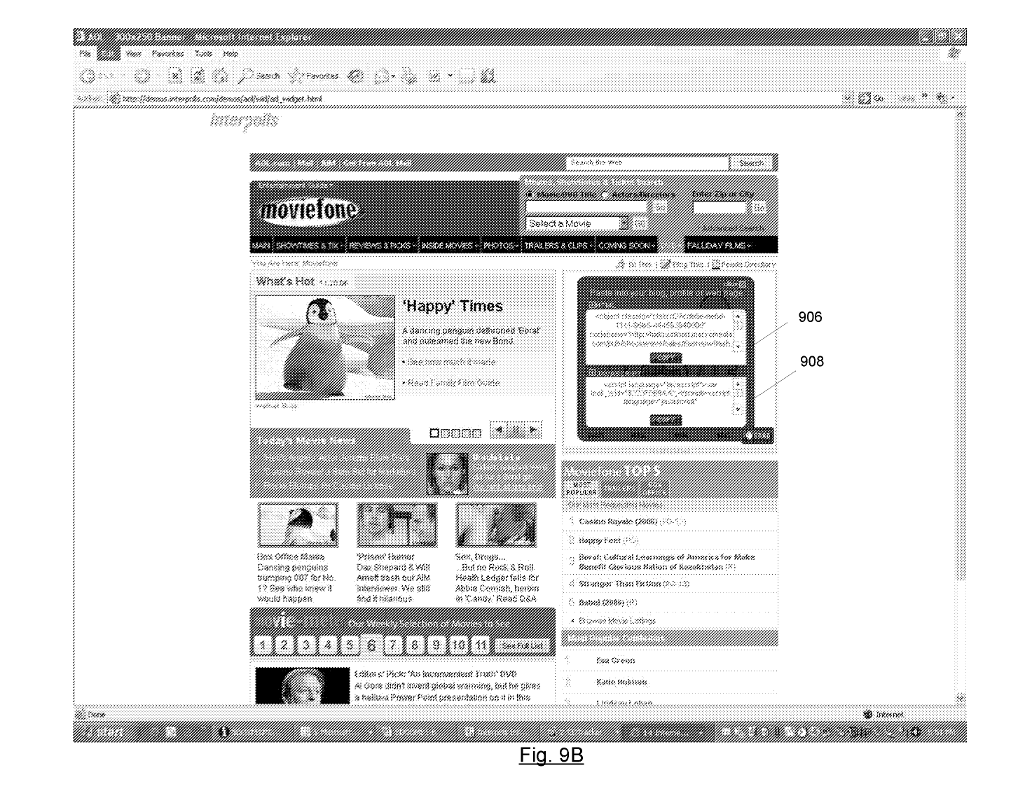

FIG. 9A is a depiction of a widget that is embedded within an Affiliate web page, in accordance with one embodiment. As depicted, the web advertisement unit 902 contains a widget that includes a “Grab” button 904. When a user selects the “Grab” button 904, the web advertisement unit reveals the base code segment for the widget. As depicted in FIG. 9B, the base code can be either in HTML 906 or JAVASCRIPT 908. It should be understood, however, that the widget can be created using any programming language as long as it can be executed on a conventional web browser.

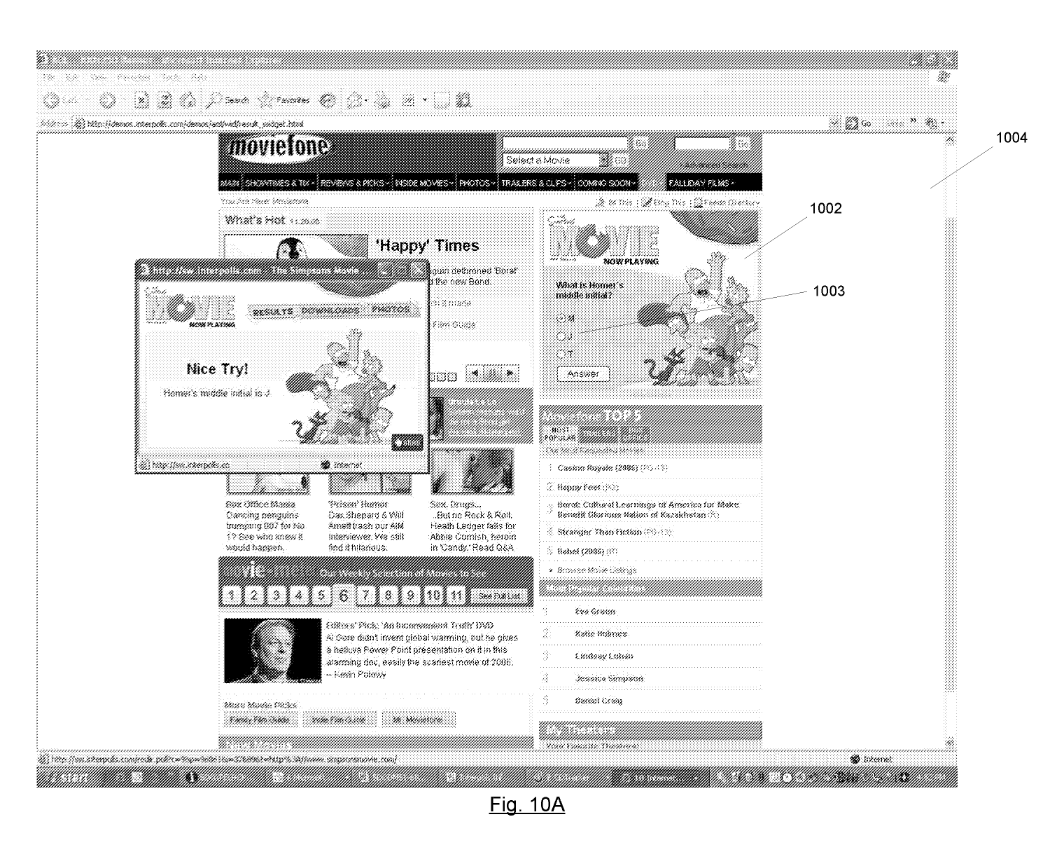

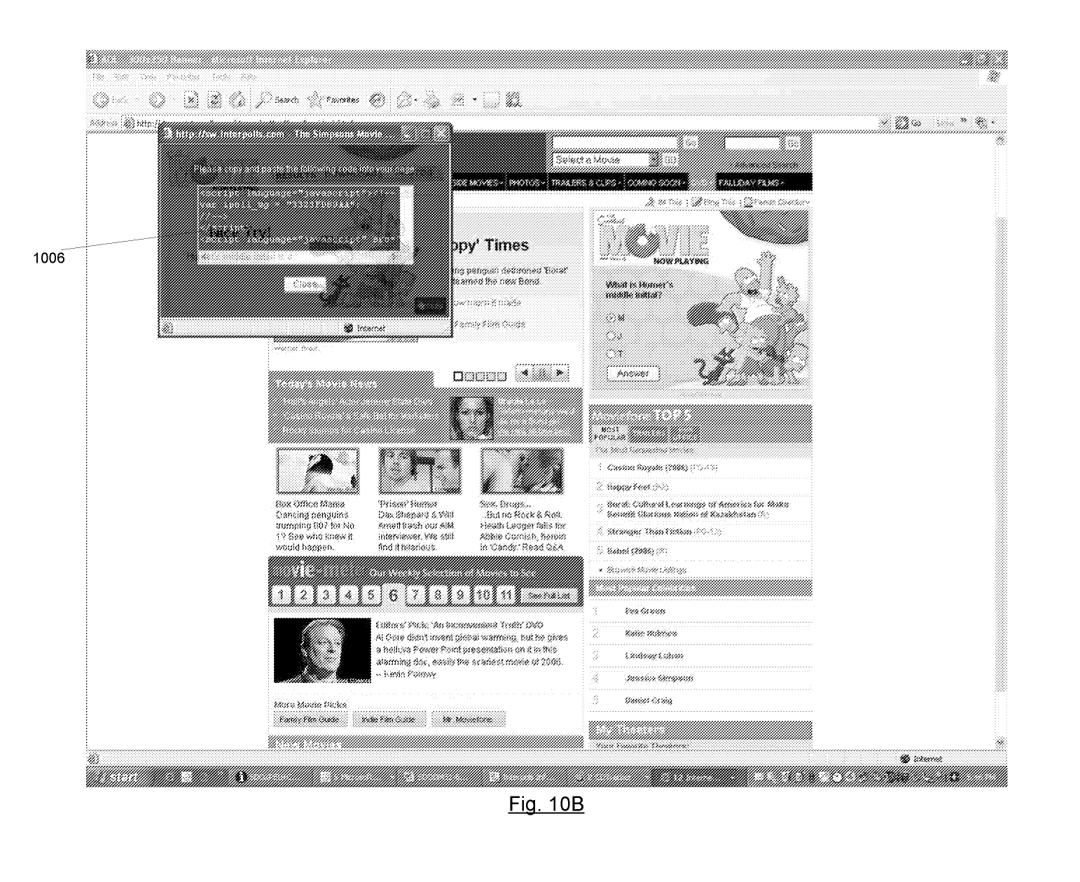

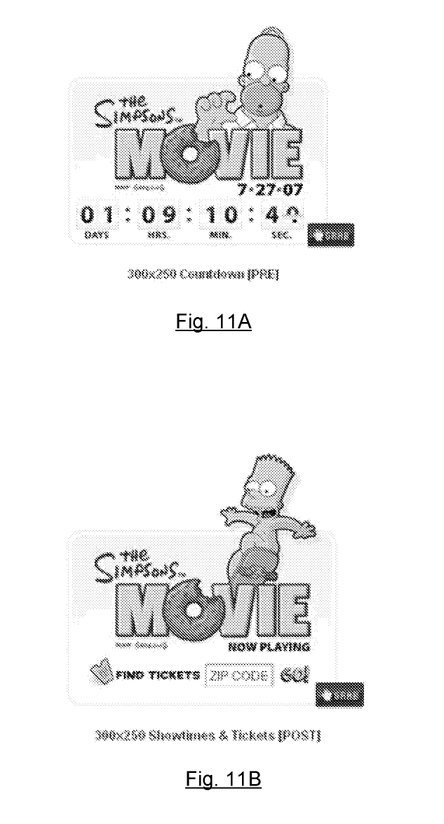

FIGS. 10A and 10B illustrate a rich media widget integrated within a rich media web advertisement unit and selectively delivered to a user based on his/her interactions with ad unit, in accordance with one embodiment. As depicted in FIG. 10A, a rich media web advertisement unit 1002 is embedded within an Affiliate web page 1004. The ad unit 1002 includes online query content 1003 designed to encourage a user to submit his/her answer to a query question about character(s) in THE SIMPSONS MOVIE. After the user selects a radio button (i.e., M, J, or T) and submits the answer, the information is communicated back to the ad server(s) which then returns an appropriate rich media widget (as a standalone web advertisement unit) to the user based on the selection. If the user chooses to incorporate the rich media widget into his/her social networking page (e.g., MYSPACE, FRIENDSTER, etc.) and/or personal homepage; the user can proceed with selecting the Grab” button to reveal the base code segment for the rich media widget. As depicted in FIG. 10B, the base code is in JAVASCRIPT 1008. It should be appreciated, however, that the rich media widget can be created using any programming language as long as it can be executed on a conventional web browser.

FIGS. 11A & 11B illustrates a rich media widget that transitions one configuration to another based on a timed (or metered) setting, in accordance with one embodiment. As depicted in FIG. 11A, the rich media widget shown is in a counter type “pre-event” configuration that ticks off the days, hours, minutes and seconds until the date THE SIMPSONS movie is due in theatres (the event). The widget is also configured with a built-in internal clock (or counter/meter) that triggers the transformation of the widget into a ticket locator type “post-event” configuration (See FIG. 11B) when it counts down to the event. The ticket locator functionality allows a user to enter a zip code to locate where theatre tickets for the movie are still available within the entered zip code. The “post-event” widget may take on alternative configurations other than being a ticket locator. For example, the “post-event” widget may be in a configuration to present an end card to inform/alert users to go to a designated page to grab another widget or other types of content. It should be appreciated that the “post-event” widget may be transformed into any configuration as long as it can be rendered by a conventional web browser.

In certain embodiments, multiple web advertisement units may be presented to the user at the same time. That is, two or more web advertisement units are rendered on the same web page. In one embodiment, these multiple ad units are standalone units that do not directly interact with each other. In another embodiment, the multiple ad units can be configured such that they interact with one another and/or the user; and based on those interactions the ad server(s) (i.e., the System 120) can be configured to return various web ad units back to the user.

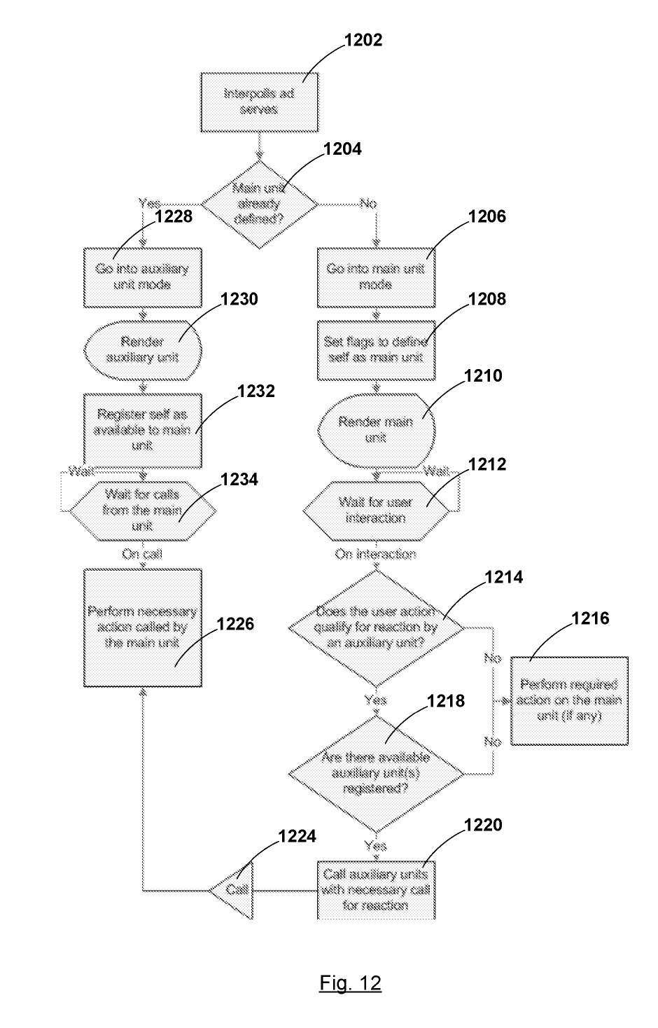

FIG. 12 is a diagram illustrating an example process for multiple web advertisement units to communicate and interact with each other on the same webpage, in accordance with one embodiment. In step 1202, a web ad unit is served by the ad server to a client's web browser via a TCP/IP-based Internet connection using a Hypertext Transfer Protocol (HTTP) or equivalent communications transmission protocol. In step 1204, the web ad unit is configured to detect whether a main ad unit has already been defined on the webpage. That is, the ad unit actively looks to see if there are any other rendered ad units on the webpage that share common attributes with it and have been designated as a main ad unit. In one embodiment, the common attributes are that the web ad units share the same ad campaign objectives. For example, the ad units may all be geared towards getting Internet users to visit a website that is selling product “A.” Therefore, a first ad unit may have a banner ad relating to product “A,” a second ad unit may play streaming video about the same product, while a third ad unit may present polls asking users to rate features they would like product “A” to have.

In another embodiment, the common attributes are that the web ad units share the same client. For example, all the web ad units may share Company “A” as a common client. Alternatively, a first web ad unit may relate to Subsidiary “A,” while a second web ad unit may relate to Subsidiary “B”, both subsidiaries “A” and “B” belonging to Company “A.” In still another embodiment, the common attributes are that the web ad units relate to the same client type. For example, the ad units may all relate to clients in the same industry (i.e., automotive industry), industry sub-segment (e.g., automotive parts, automotive repair, car dealerships, etc.), or other common trait (e.g., clients who cater to selected professionals, demographics, genders, etc.).

In a different embodiment, the common attributes are that the web ad units relate to certain custom features within the ad units. For example, these ad units can be setup in any arbitrary way for them to be connected with other ads. That is, the common attributes can be that the ads have a combination of the same clients, same advertising campaign or interact simply because they happen to be served onto a same page. Essentially any detectable ad feature can be mixed and matched as common attributes. It should be appreciated, however, that these are just examples of some common shared attributes between web ad units and that the shared attributes can essentially be any characteristic as long as it can be recognized by programmable logic infused into the ad units. That is, essentially any arbitrary condition can be programmed into the main ad units and auxiliary ad units for them to flag and recognize each other. For example, the “master” unit can be configured to specifically seek out a particular “slave” unit with particular questions and have the master unit completely change the look and feel of the slave unit.

Continuing with FIG. 12, if a main ad unit has not been already rendered, the process proceeds to step 1206 where the ad unit is configured to automatically convert itself into the main ad unit by setting “flags” in step 1208 to define itself as the main ad unit for the webpage. In one embodiment, those flags are HTML based tags that identify the ad unit as a main ad unit to other ad units. In another embodiment, those flags are XML based tags that identify the ad unit as a main ad unit to other ad units.

In step 1210, the newly “tagged” main ad unit is rendered onto the webpage that is currently open in the web browser. In step 1212, the rendered main ad unit switches into a “wait” mode whereby it suspends further action until a user interacts with it in some fashion. This may be through a user placing a mouse pointer over the main ad unit and clicking on the main ad unit. Or, it may involve the user submitting information to the main ad unit through the addition of text or the clicking of buttons rendered on the main ad unit.

Once a user interacts with the ad unit, the process proceeds to step 1214, where the main ad unit determines if the user action qualifies for some reaction by an auxiliary unit. If not, the process proceeds to step 1216 where the main ad unit performs any required action resulting from the user interaction with the main ad unit. If the user action qualifies some action by an auxiliary unit, the process proceeds to step 1218 where the main ad unit determines if there are any available auxiliary units that are registered with the main ad unit. That is, first, the main ad unit determines whether there are any auxiliary ad units that are registered to it and, second, whether any of those registered auxiliary ad units are available. If there are not any available registered auxiliary ad units, the process proceeds back to step 1216 where the main ad unit performs any required action resulting from the user interaction. If there are available registered ad units, the process proceeds to step 1220, where the main ad unit is configured to generates calls that contain the appropriate sets of instructions to select designated auxiliary ad units.

These instructions are imbedded with messaging, images, rich media content and technical features that are designed to enhance the utility of the auxiliary ad units. Examples of the types of rich-media content that can be embedded in the instructions include, but are not limited to, streaming video, questions, data forms, coupons, multiple universal resource locators (URLs), XML feeds, and other advanced features that can be implemented in HTML. It should be appreciated, however, that essentially any technical feature and/or content type can be imbedded into the instructions and communicated to the auxiliary ad units as long as it can be rendered on a webpage.

In step 1224, the calls are communicated by the main ad units to the designated auxiliary ad units. In step 1226, the auxiliary ad units perform the necessary actions called for by the sets of instructions sent by the main ad unit.

Staying with FIG. 12, if a main ad unit has already been rendered, the process proceeds to step 1228 where the ad unit automatically converts itself into auxiliary unit mode. That is, the ad unit takes on the role of an auxiliary ad unit. In step 1230, the newly converted auxiliary ad unit is rendered on the webpage by the web browser. In step 1232, the auxiliary ad unit registers itself as “available” to the main ad unit with which it shares the same common attributes with. In step 1234, the newly registered auxiliary ad unit switches into a “wait” mode whereby it suspends further action until it receives a call from the main ad unit it is registered with at which time the process proceeds to step 1226. In step 1226, the auxiliary ad unit perform the necessary actions called for by the sets of instructions sent by the main ad unit.

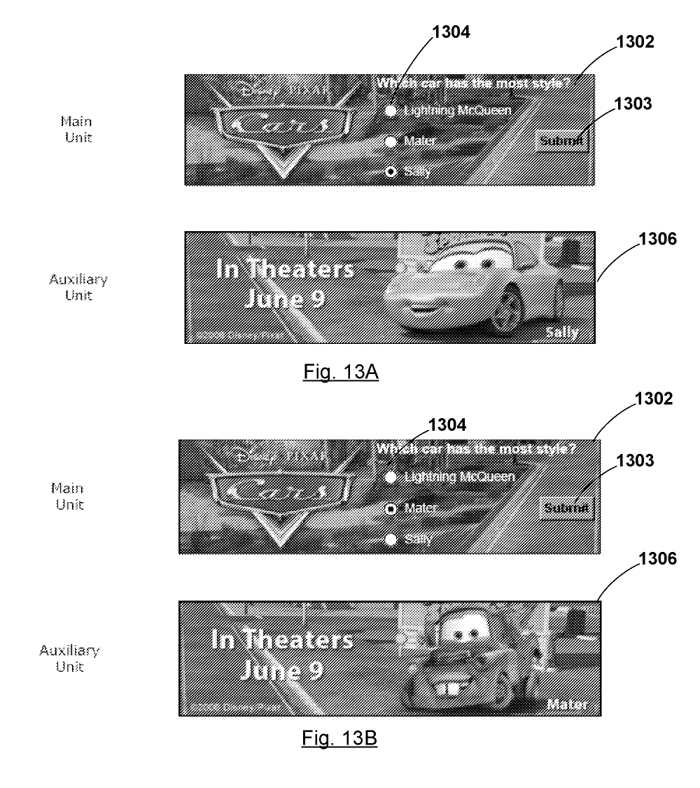

FIGS. 13A and 13B provides an example of how a main ad unit communicates and interacts with an auxiliary ad unit on a webpage, in accordance with one embodiment. As depicted in FIG. 13A, the main ad unit 1302 has a list of checkboxes 1304 that allows users to choose (“Which car has the most style?”). Upon selection, the checkboxes 1304 are marked appropriately and the user can click the “submit” button 1303 to input their preference. Upon submission of the selection, the main ad unit 1302 is configured to generate and communicate instructions to the auxiliary ad unit 1306 that is registered to it. Once the auxiliary ad unit 1306 receives the instructions it is configured to execute those instructions. As shown in FIG. 13A, the auxiliary ad unit 1306 changes to a banner ad that depicts the car model (i.e., the “Sally” character) selected by the user.

FIG. 13B, depicts what happens when a user selects a different checkbox (the “Mater” character checkbox) 1304 on the main ad unit 1302. As depicted, the auxiliary ad unit 1306 changes the banner ad to show the “Mater” character selected by the user. The same interaction between the main ad unit 1302 and the auxiliary ad unit 1306 will occur regardless of which checkbox is chosen by the user.

In one embodiment, instead of a list of checkboxes 1304, a query field is provided by the main ad unit 1302 to the user. For example, the main ad unit 1302 may allow the user to submit a query for specific content (i.e., movie clips, graphics, text content, etc.) from an advertiser associated with the main ad unit 1302. The results of the query can then be displayed on the auxiliary ad unit 1306 registered to the main ad unit 1302. In another embodiment, the main ad unit 1302 is configured to render an interactive game that is responsive to user interactions. For example, when a user interacts with the game on the main ad unit 1302, depending on the nature of the interaction, the main ad unit 1302 can send appropriate instructions to the auxiliary ad unit 1306 registered to the main ad unit. The auxiliary ad unit 1306 can then execute and display the actions provided for in the instructions. It should be understood, however, that these are but just some examples of how a main ad unit 1302 and auxiliary ad unit 1306 may interact with each other and that these interactions can take any form as long as the main ad unit 1302 can be configured to generate executable instructions that lay out the interactions to the auxiliary ad units 1306 (registered to the main ad unit 1302).

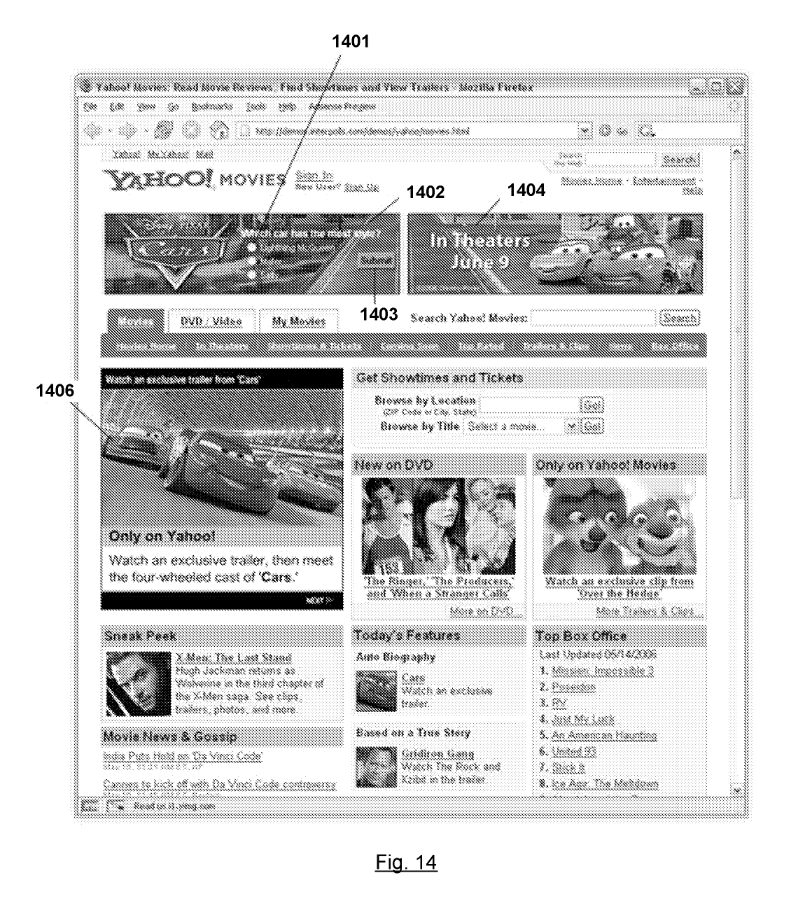

FIG. 14 is a depiction of how a main ad unit can interact with multiple auxiliary ad units on a webpage, in accordance with one embodiment. As shown, herein, a main ad unit 1402, a first auxiliary ad unit 1404 and a second auxiliary ad unit 1406 is rendered on a webpage. The main ad unit 1402 has a list of checkboxes 1401 that allows users to choose (“Which car has the most style?”). Upon selection, the checkboxes 1401 are marked appropriately and the user can go ahead and click the “submit” button 1403 to input their preference. Upon submission of the selection, the main ad unit 1402 is configured to generate and communicate instructions to the first auxiliary ad unit 1404 and the second auxiliary ad unit 1406 that are registered to it. Once the auxiliary ad units (1404 and 1406) receive the instructions they are configured to execute those instructions.

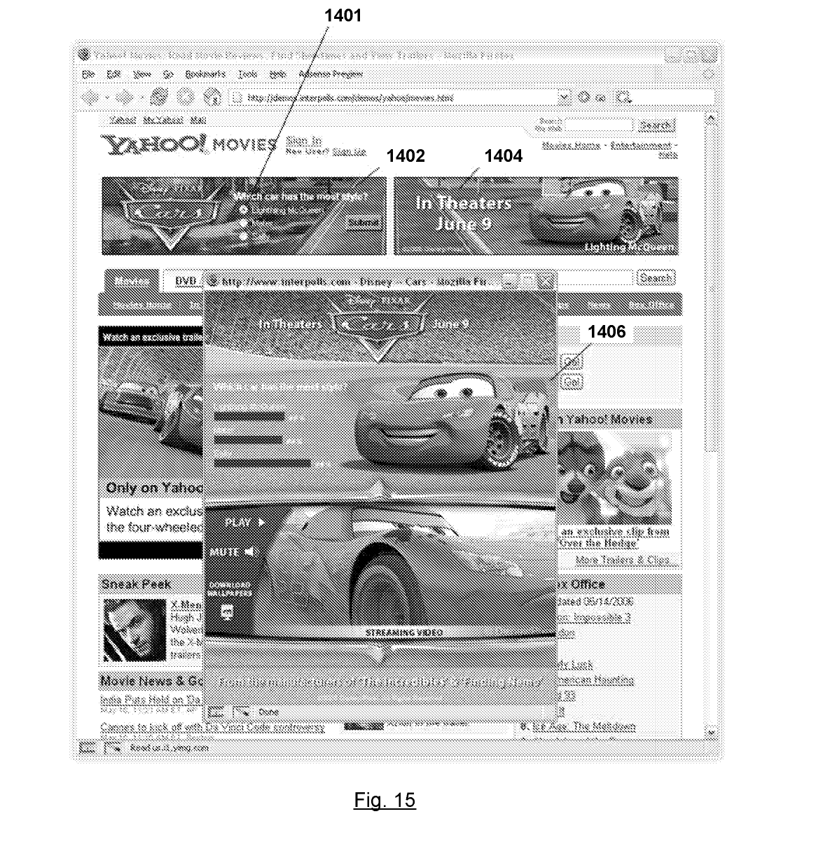

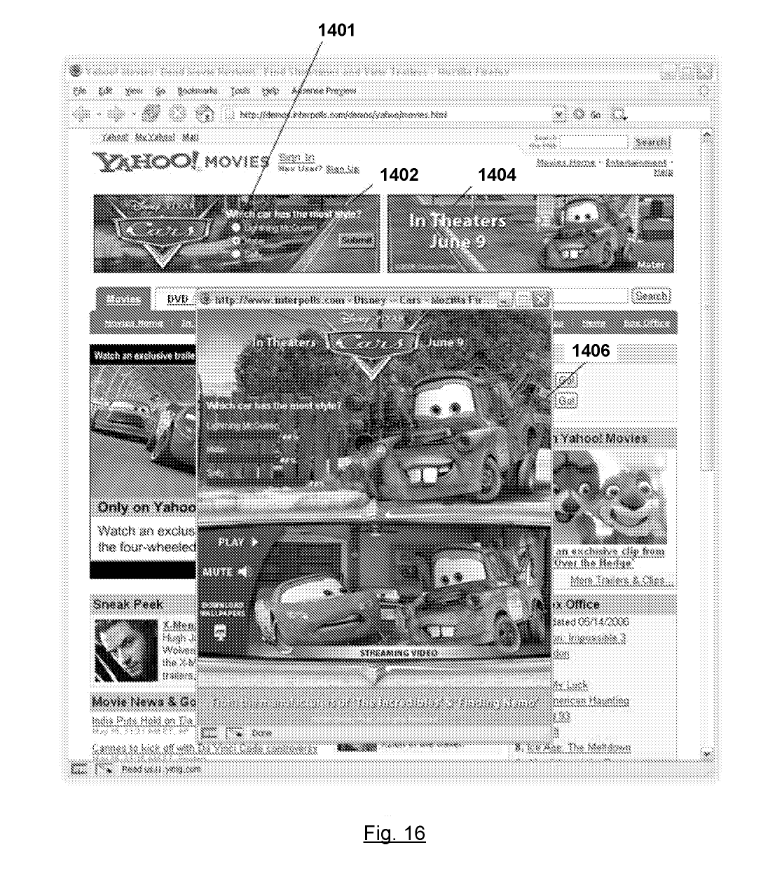

For example, as depicted in FIG. 15, the first auxiliary ad unit 1404 changes to a banner ad that depicts the car model (i.e., the “Lightening McQueen” character) selected by the user in response to the instructions provided by the main ad unit 1402. The second auxiliary ad unit 1406 then retrieves aggregate voting results and multimedia clips (e.g., video, audio, graphics) associated with the selected car model (i.e., “Lightening McQueen”) from a database server (designated by the main ad unit 1402 instructions) and then displays them to the user. These same interactions between the main ad unit 1402 and auxiliary ad units (1404 and 1406) are repeated in FIG. 16, when the user selects “Mater” as the selected car model on the main ad unit 1402.

It should be appreciated that the interactions between three ad units (1402, 1404 and 1406) were shown here by way of example only. In practice, the same underlying communications and interactive principles between ad units can be replicated for as many ad units as can be rendered on a webpage. That is, the main ad unit 1402 can be configured to accommodate as many auxiliary ad units (1404 and 1406) as can be rendered on a webpage.

In certain embodiments, the user's interactions with the multiple ad units (main ad unit and auxiliary ad units) are communicated to the ad server(s) (i.e., the System 120) which then processes the information before selecting and delivering additional web advertisement units back to the user. For example, as depicted in FIGS. 13-16, a user can interact with a main ad unit 1402 that has a list of checkboxes 1401 that prompts the user to choose (“Which car has the most style?”). Once the user selects one of the checkboxes 1401, an auxiliary ad unit can retrieve aggregate voting results and a selection of multimedia clips (e.g., video, audio, graphics) associated with the selected car model (i.e., “Lightening McQueen”) from a database server (designated by the main ad unit 1402 instructions) and then display them to the user. When the user selects one of the multimedia clips, the selection information can be communicated to the ad server(s) (i.e., the System) such that a new web advertisement unit containing the selected multimedia clip can be sent back to the user. That is, additional web ad units can be delivered to a user based on his/her interactions with multiple ad units. It should be appreciated that the additional web advertisement units can contain any type of web advertisement content (e.g., static graphical banners, interactive polls/queries, interactive games, multimedia clips, streaming video, syndicated news, multimedia feeds, etc.) as long as the content can executed on a conventional web browser.

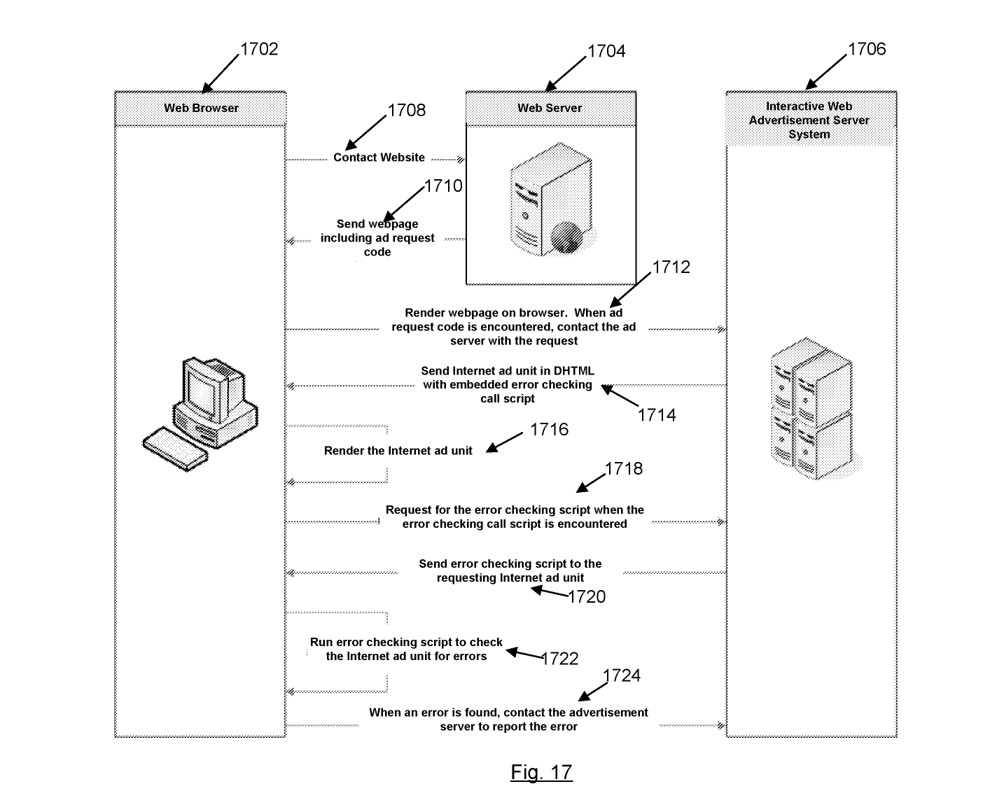

FIG. 17, is a diagram illustrating an example process for identifying formatting errors in an Internet advertisement, in accordance with one embodiment. First, in step 1708, the web browser 1702 can contact the web server 1704 (e.g., Internet content server, affiliate website server, etc.) to deliver a webpage associated with a website that is stored on the server 1704. In one embodiment, the webpage is in HTML format. In another embodiment, the webpage is in XHTML format. It should be understood, however, that the webpage can essentially be created in any hypertext language format as long as a web browser 1702 can be configured to properly render the webpage.

In step 1710, the web server 1704 returns a webpage to the web browser 1702 along with an ad request script (i.e., ad request code) that is configured to direct the web browser 1702 to request an advertisement unit to be sent from the web advertisement server system 1706. Typically, the webpage is requested and served from the web server 1704 using Hypertext Transfer Protocol (HTTP) or equivalent communications transmission protocol. In one embodiment, the ad request script is directly embedded within the webpage that is returned to the web browser 1702. In another embodiment, the web server 1704 delivers an ad server code (served in conjunction with the webpage) that calls for the ad request script to be sent to the web browser 1702. The ad request code can be written using a number of different programming languages, the most common of which are JAVASCRIPT™, VBSCRIPT™, and ACTIONSCRIPT™.

In step 1712, the webpage is rendered by the web browser 1702 and when the ad request script is encountered, the web browser 1702 can contact the web advertisement server system 1706 with a request for an advertisement unit. In one embodiment, once the request is received the web advertisement server system 1706 is configured to examine an existing profile of a user associated with the web browser 1702 before choosing an appropriate advertisement unit to return back to the web browser 1702. Typically, the existing profile contains historical information regarding previous communication sessions between the web advertisement server system 1706 and the user. If a profile does not already exist for the user, the advertisement server system 1706 is further configured to create a new profile for the user and log the identity of the advertisement unit that is eventually selected and delivered to the user.

In one embodiment, the client profiles are stored in a storage area (e.g., partitioned memory space, extra hard drive, etc.) within the advertisement server system 1706. In another embodiment, the profiles are stored on an external storage medium (e.g., hard drive, CD-ROM, etc.) that is communicatively linked to the web advertisement server 1706. Examples of historical information that may impact the advertisement units chosen include: information about advertisement units that have already been sent to the user, information regarding user response to those previous advertisements, and user demographics information.

In another embodiment, once the request is received, the advertisement server system 1706 is configured to choose an advertisement unit to send based on the content of the webpage that was sent from the web server 1704 to the web browser 1702. In still another embodiment, the web advertisement server 1706 is configured to choose an advertisement unit based on historical information and whether the content rating (e.g., G ‘general audience’, PG ‘parental guidance suggested’, PG-13 ‘parental guidance suggested for those under 13 years of age’, and R ‘restricted for those under 17 years of age’, etc.) of the advertisement unit exceeds the content rating level of the web page.

Moving on to step 1714, the advertisement server system 1706 can send the advertisement unit, chosen during step 1712, to the web browser 1702. In one embodiment, the advertisement unit is created in DHTML format. In another embodiment, the advertisement unit is created in a combination DHTML/CSS format. It should be understood that the advertisement unit can be created in any hypertext markup language format as long as a plug-in is not required in order for the unit to be rendered in a web browser 1702.

Embedded within the advertisement unit is an error checking call script that is configured to direct the web browser 1702 to request the advertisement server to send an error checking script. In one embodiment, the error checking call script is written in JAVASCRIPT™. In another embodiment, the error checking call script is written in VBSCRIPT™. In still another embodiment, the error checking call script is written in ACTIONSCRIPT™.

In step 1716, the advertisement unit is received by the web browser 1702 and can be rendered by the same. Typically, this involves the web browser 1702 parsing the underlying HTML of the advertisement unit and rendering the unit in accordance with the specifications and instructions set therein.

Continuing on to step 1718, when the error checking call script is encountered during the rendering of the advertisement unit, a request can be generated to call for an error checking script to be sent from the advertisement server system 1706 to the unit. In one embodiment, the error checking script is uniquely associated with the rendered ad unit. That is, the error checking script requested can only be applied to check a rendered advertisement unit with a specific ad unit identification (ID) code. In another embodiment, the error checking script in non-specific to any advertisement unit. That is, the error checking script can be “universally” applied to check any rendered advertisement unit.

In step 1720, the advertisement server system 1706 sends the error checking script to the requesting advertisement unit. Typically, the error checking script is requested and served from the advertisement server system 1706 using HTTP or equivalent communications transmission protocol.

Proceeding on to step 1722, the error checking script is executed to check the advertisement unit for errors. This is done by comparing the physical parameters of the rendered advertisement unit against predicted advertisement unit parameters. Examples of advertisement unit parameters include, but are not limited to: the physical dimensions (i.e., height and width) of the advertisement unit, the position of the advertisement unit relative to other features rendered in the web browser 1702, the look and feel of various components (e.g., borders, padding spaces, etc.) of the advertisement unit, etc. It should be appreciated that essentially any aspect of the advertisement unit can be checked by the error checking script as long as that aspect can be translated into a measurable parameter that can be recognized by the error checking script. An error is logged whenever the rendered an ad unit parameter value fails to match its associated predicted ad unit parameter value.

As alluded to above, there are various things the error checking script can check for during the matching operation. In one embodiment, the error checking script can look for items with conflicts that resides on the webpage and adjusts accordingly. This usually happens when there are multiple expanding ad units on a single webpage. In another embodiment, the error checking script can look for all items on the webpage to see if there are things covering the ad unit. This is a real problem on some sites where their malformed CSS layers will cover the advertisement buttons so it can't be clicked on and such.

In still another embodiment, the error checking script catalogs every single visible element and checks their size to make sure they are within specifications. It does this by comparing how big the element is to how much of the element is visible. If the visible area of the element is smaller than the actual size of the element (and it's not by design), the script concludes that something is getting cut-off during rendering or that something else is wrong.

When the error checking script reports back the errors, it reports back with as much information about the user's configuration as it can. Including user's screen width and height, browser type, browser version, OS version, actual URL of the website that was serving the ad that the user was on, etc.

The advertisement server system 1706 typically does not get alerted for every single error identified by the script (users are bound to have their fonts too big, or have some international language font that's pushing things out, etc.) so only when a predetermined threshold is reached, will the error checking script alert the advertisement server system 1706. After, either the advertisement server system 1706 or a system administrator can sift through the report to address the identified problems. That predetermined threshold can be set to anything, a percentage of the impressions that generate an error, a specified error count number reached, etc.

In one embodiment, the advertisement server system 1706 can automatically classify the errors to indicate their level of severity. In another embodiment, the system administrator reviews the errors logged by the advertisement server system 1706 and manually classifies them based on severity.

In step 1724, all the errors identified by the error checking script are compiled into a report. In one embodiment, the report is sent back to the advertisement server system 1706 and stored for viewing by a system administrator. In another embodiment, the report is sent back to the advertisement server system 1706 and processed to supply the advertisement server system 1706 with the information necessary to create a new advertisement unit that corrects for the errors in the rendered unit.

Examples of the types of errors that can be identified by the error checking script include: misaligned ad unit elements, deformed ad unit buttons, ad units that are too large, ad units that are too tall, ad units that contain irregular borders and padding spaces, and ad units with elements that are forced aligned to one side. It should be understood, however, that the types of errors presented above are provided here by way of example only, in practice the error checking script can be configured to identify essentially any type of error as long as it can be translated into a measurable parameter that can be recognized by the error checking script.

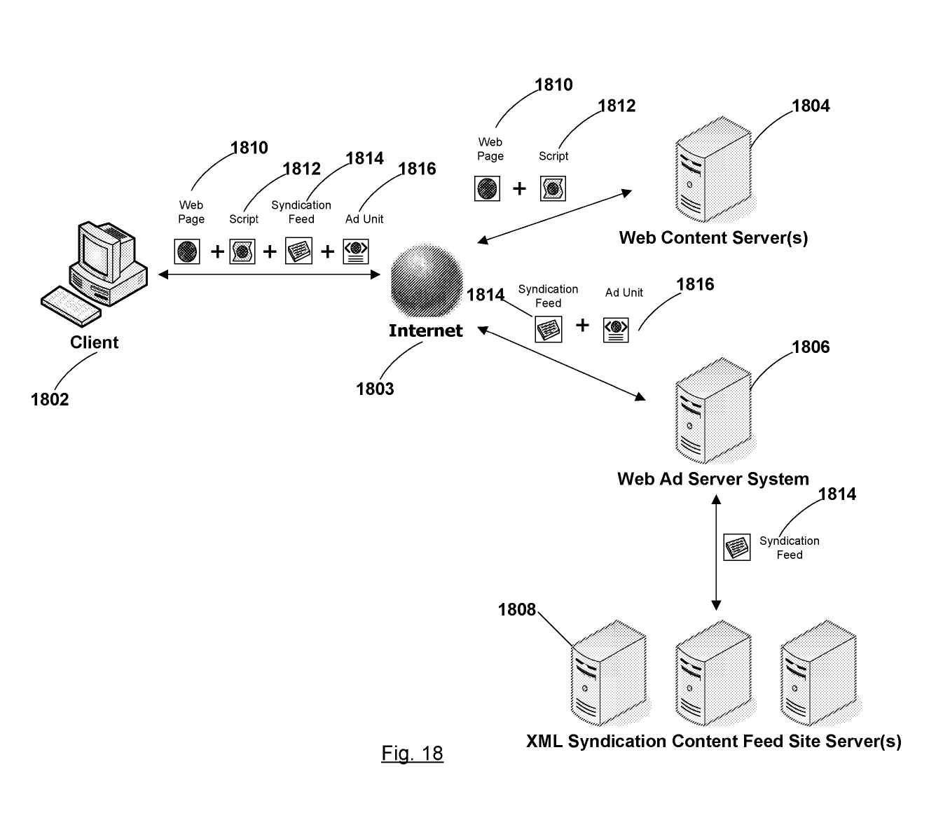

FIG. 18 is an illustration of how multiple Internet content servers can work collaboratively to deliver Internet advertising and XML-based syndication content to a client, in accordance with one embodiment of the systems and methods described herein. As depicted, a client 1802 using a web browser is in communications by way of the Internet 1803 with a web content (Affiliate) server 1804, a web ad server system 1806, and a XML syndication content feed site server 1808. It should be appreciated that the client 1802 can be in communications with multiple servers of each server type (e.g., web content (Affiliate) server 1804, web ad server system 1806, etc.) and that single servers were used in this depiction for the sake of simplicity and is not intended to limit the scenario to single servers of each server type.

The XML syndication content feed site server 1808 may be connected to the web ad server system 1806 by way of the Internet 1803, a local area network connection, or any equivalent thereof. During an Internet 1803 web surfing session, the client 1802 makes a request for a web page 1810 from the web content (Affiliate) server 1804, which is configured to send the requested page 1810 back to the client 1803 in the form of a Hypertext Markup Language (HTML) or equivalent file type, e.g., XML, Extensible Hypertext Markup Language (XHTML), and Extensible Bindings Language (XBL). Embedded within the web page 1810 is a script 1812 that instructs the clients' 1802 web browser to send a request for advertisement units 1816 to be sent from the web ad server system 1806 to the client 1802. Examples of programming languages that can be used to create the script 1812 include, JAVASCRIPT™ and VBSCRIPT™. It should be understood, however, that the script 1812 can be created using any programming language as long as the script 1812 can be processed by the client's 1802 web browser to initiate a request for an advertisement panel from the web ad server system 1806.

Still with FIG. 18, in one embodiment, once the request is received the web ad server system 1806 is configured to examine an existing profile of the client 1802 before choosing an appropriate advertisement unit 1816 to return back to the client 1802. Typically, the existing profile contains historical information regarding previous communication sessions between the web ad server system 1806 and the client 1802. If a profile does not already exist for the client 1802, the web ad server system 1806 is further configured to create a new profile for the client 1802 and log the identity of the advertisement unit 1816 that is eventually selected and delivered to the client 1802. In one embodiment, the client profiles are stored in a storage area (e.g., partitioned memory space, extra hard drive, etc.) within the ad server system 1806. In another embodiment, the profiles are stored on an external storage medium (e.g., hard drive, CD-ROM, etc.) that is communicatively linked to the ad server system 1806. Examples of historical information that may impact the advertisement units 1816 chosen include: information about advertisement units 1816 that have already been sent to the client 1802, information regarding client 1802 response to those previous advertisements 1816 (e.g., online queries, polls, trivia, etc.), and client 1802 demographics information.

In another embodiment, once the request is received, the web ad server system 1806 is configured to choose an advertisement unit 1816 to send based on the web content (Affiliate) server 1804 that the client 1802 was in communications with prior to the creation of the request. In still another embodiment, the web ad server system 1806 is configured to choose an advertisement unit 1816 based on historical information and whether the content rating (i.e., G ‘general audience’, PG ‘parental guidance suggested’, PG-13 ‘parental guidance suggested for those under 13 years of age’, and R ‘restricted for those under 17 years of age’, etc.) of the advertisement unit 1816 exceeds the content rating level of the web page 1810.

After choosing the ad unit 1816, the web ad server system 1806 is configured to convert a XML syndication feed 1814 into a format appropriate for web browser viewing (e.g., HTML, XHTML, etc.) and embed the converted XML syndication feed 1814 into the ad unit 1806. The web ad server system 1806 is further configured to send that ad unit 1816 to the client 1802 web browser when the web ad server system 1806 receives a request for the ad unit 1816 from the client 1802 web browser. As discussed previously, a script embedded within the web page 1810 that the client 1802 web browser receives from the web content (Affiliate) server 1804 instructs the client 1802 web browser to make the request for the ad unit 1816. Once the client 1802 receives the ad unit 1816, the client's 1802 web browser renders both the contents of the ad unit 1816 and the converted XML syndication feed 1814 for viewing by the client 1802.

In one embodiment, the XML syndication feed 1814 is created using a RSS-based format such as RDF Site Summary, Rich Site Summary, or Really Simple Syndication. In another embodiment, the syndication feed 1814 is created using an Atom-based format such as the Atom Syndication Format (ASF). It should be appreciated that the syndication feed 1814 can be created using any XML-based format as long as the syndication feed 1814 can be converted into a format appropriate for client 1802 web browser viewing prior to being embedded into an advertisement unit 1816.

Continuing with FIG. 18, the types of content that can be delivered by the syndication feed 1814 is diverse and may include text, pictures, audio, and video elements. The various content delivered by the feed 1814 generally relate to a particular subject matter that may or may not be relevant to what is being marketed in the advertisement unit 1816. In one embodiment, the contents of the XML syndication feed 1814 relate to the subject of the advertisement unit 1816 itself. For example, if the advertisement unit 1816 is marketing a new car model, the XML feed 1814 may be an online query that questions the client 1802 about a preferred car make or model. In another embodiment, the content of the XML syndication feed 1814 is chosen based on the client's 1802 interactions with the advertisement unit 1816. For example, a client 1802 using a mouse to click on an object or character depicted in the advertisement unit 1816 may result in a XML syndication feed 1814 providing news or information about the object or character. Examples of programming languages that can be used to create advertisement units 1816 that enable interactions with the user include JAVASCRIPT™, VBSCRIPT™, ACTIVEX™, or FLASH(LIVESCRIPT)™. It should be understood, however, that any programming language can be used to create interactive advertisement units 1816 as long as the resulting unit 1816 can be delivered through the Internet 1803 and be rendered by a web browser.

As depicted, the ad server system 1806 is configured to retrieve XML syndication content feed(s) 1814 from the XML site server 1808 and provide temporary cache storage of the XML syndication feed 1814 prior to the client 1802 retrieving the feed 1814 from the web ad server system 1806 via the Internet 1803. These syndication content feed(s) 1814 are configured to be dynamically updatable. The XML site server 1808 is configured to send XML syndication feed 1814 updates to the ad server whenever the XML site server 1808 receives a request for updated XML content from the web ad server system 1806. In one embodiment, the request is self-initiated by the web ad server system 1806 in accordance with a set interval schedule (e.g., time, etc.). For example, the web ad server system 1806 can be programmed to retrieve updates according to a time based interval (e.g., days, minutes, hours, etc.) schedule. In another embodiment, the request for updated content is initiated in response to a call for updated content by the client 1802. In still another embodiment, the request for updated content is initiated in response to a call for updated syndication feed content by the aggregator component (i.e., feed reader) of the client 1802 web browser. In still yet another embodiment, the request is initiated when the syndication feed 1814 content in the web ad server system 1806 cache has remained static (not updated) for a pre-determined period of time. It should be understood that essentially any trigger can be used to initiate a web ad server system 1806 request for syndication feed 1814 updates as long as the ad server can be configured to process and understand that trigger.

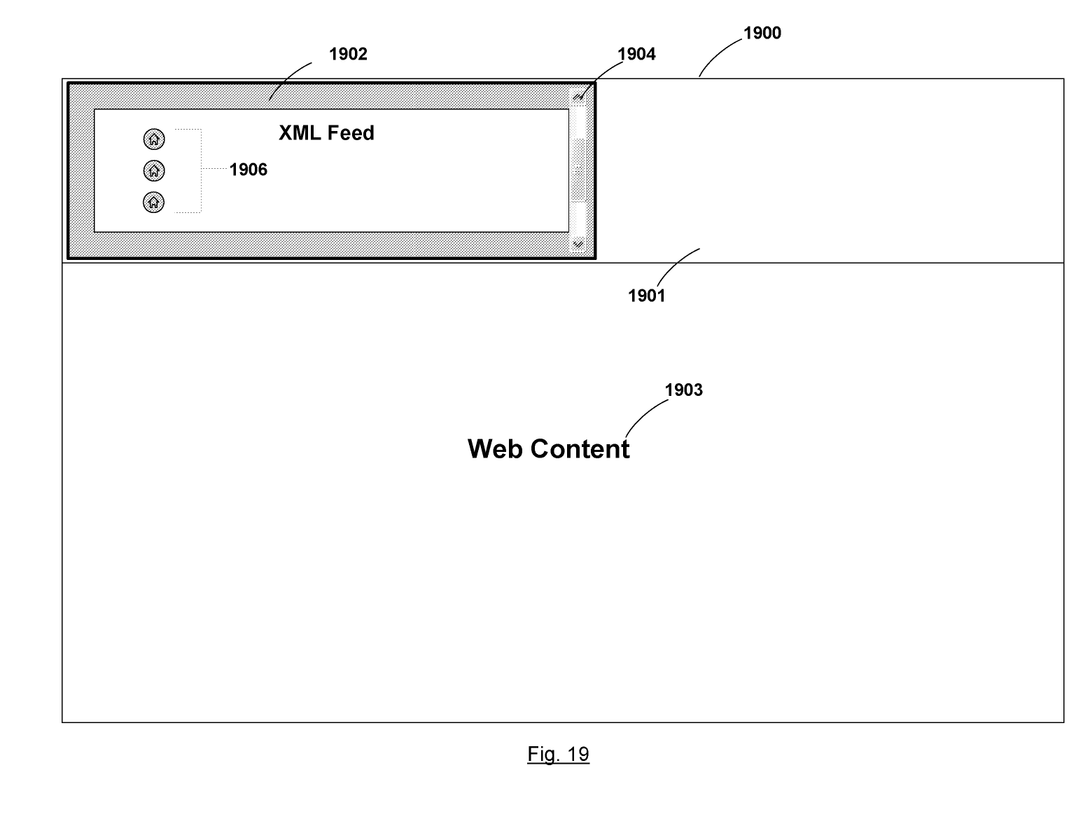

FIG. 19 is an illustration of a web browser window that includes an advertisement unit with a XML syndication feed embedded within, in accordance with one embodiment. As shown herein, the browser window 1900 includes an Internet advertising unit 1901 that is positioned above web content 1903 in the browser 1900. The advertising unit 1901 includes an embedded XML content feed 1904 that has been converted into a format (i.e., HTML, XHTML, etc.) appropriate for web browser viewing within its boundaries. The XML syndication feed 1902, as depicted herein, has a plurality of hyperlinks 1906 each linked to specific web content 1903 by way of a Universal Resource Locator (URL) address set within the hyperlink 1906. It should be appreciated, however, that the XML content feed 1902 may contain any type of web content (i.e., text, images, video, etc.) 1903 as long as the content 1903 can be displayed by the browser 1900 hosting the feed 1902. In one embodiment, a text summary detailing the specifics of the web content that each hyperlink 1906 is associated with is positioned adjacent to each of the hyperlinks 1906. In another embodiment, a summary of the web content 1903 associated with each hyperlink 1906 becomes visible to the user when a mouse pointer is positioned substantially over the hyperlink 1906.

By using a scroll bar 1902, the user can scroll through the entire list of hyperlinks 1906 available to the XML syndication feed 1902. Each hyperlink 1906 may be associated with web content 1903 that may be in the same or in different formats (e.g., text, multimedia, etc.). Examples of web content 1903 that can be connected via the hyperlinks 1906 include: news stories, video feeds, product purchases, product information, sales, and marketing promotions. It should be understood that any web content 1903 can be connected by hyperlinks 1906 added to the XML syndication feed 1902 as long as the content 1903 can be accessed over the Internet and the content 1903 format is supported by the web browser 1900 hosting the syndication feed 1902.

Continuing with FIG. 19, as discussed in detail above, one significant advantage of delivering ad units 1901 embedded with a XML syndication feed 1902 is that the ad units 1901 can be continuously updated via the XML syndication content site servers that are connected to the ad server sending the dynamically updated advertisement unit 1901 to the client browser 1900. This allows for a delivery of ad units 1901 that are always updated and relevant to a user to advance the objectives of the Internet marketing campaign.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A computer implemented method for interactive delivery of self-contained advertisement units to a web browser, comprising:
requesting a webpage from an affiliate content server;
receiving the webpage in the web browser, wherein the webpage includes a request for a first self-contained advertisement unit;
rendering the webpage in the web browser, wherein the rendered webpage includes a designated space for advertisement units;
sending the request for the first self-contained advertisement unit to an advertisement server;
receiving the first self-contained advertisement unit;
rendering the first self-contained advertisement unit within the designated space for advertisement units, wherein the first self-contained advertisement unit is rendered without a plug-in application;
interacting with the first self-contained advertisement unit;
sending details of the interactions to the advertisement server;
dynamically processing the details of the interactions with the first self-contained advertisement unit to select a second self-contained advertisement unit;
sending the second self-contained advertisement unit to the web browser; and
rendering the second self-contained advertisement unit within the designated space for advertisement units, wherein the second self-contained advertisement unit is rendered without a plug-in application.

2. The computer implemented method for interactive delivery of self-contained advertisement units to a web browser, as recited in claim 1, wherein the first self-contained advertisement unit and the second self-contained advertisement unit are programmed in one of Dynamic Hypertext Markup Language (DHTML) and Cascading Style Sheets (CSS).

3. The computer implemented method for interactive delivery of self-contained advertisement units to a web browser, as recited in claim 1, wherein the second self-contained advertisement unit is configured to elicit further interactions with a user.

4. The computer implemented method for interactive delivery of self-contained advertisement units to a web browser, as recited in claim 1, wherein the first self-contained advertisement unit and the second self-contained advertisement unit are rendered from computer code segments that are configured to be portable to other web pages.

5. The computer implemented method for interactive delivery of self-contained advertisement units to a web browser, as recited in claim 1, wherein the first self-contained advertisement unit and the second self-contained advertisement unit are configured to receive and execute instructions from each other.

6. The computer implemented method for interactive delivery of self-contained advertisement units to a web browser, as recited in claim 5, wherein interactions with and between the first self-contained advertisement unit and the second self-contained advertisement unit are communicated to the advertisement server.

7. The computer implemented method for interactive delivery of self-contained advertisement units to a web browser, as recited in claim 6, wherein a third self-contained advertisement unit is selected and sent to the web browser based on the interactions with and between the first self-contained advertisement unit and the second self-contained advertisement unit.

8. The computer implemented method for interactive delivery of self-contained advertisement units to a web browser, as recited in claim 1, further including:
building a user profile based on a user's interactions with the first self-contained advertisement unit; and
embedding a cookie on the web browser to identify the user with the user profile.

9. The computer implemented method for interactive delivery of self-contained advertisement units to a web browser, as recited in claim 1, further including updating a user profile based on the user's interactions with the first self-contained advertisement unit.

10. The computer implemented method for interactive delivery of self-contained advertisement units to a web browser, as recited in claim 1, wherein the dynamic processing further includes analyzing a user profile associated with a user interacting with the web browser.

11. The computer implemented method for interactive delivery of self-contained advertisement units to a web browser, as recited in claim 1, wherein the first self-contained advertisement unit is an online query.

12. The computer implemented method for interactive delivery of self-contained advertisement units to a web browser, as recited in claim 1, wherein the first self-contained advertisement unit and the second self-contained advertisement unit includes embedded syndication content.

13. A system for interactive delivery of self-contained advertisement units, comprising:
a client web browser configured to render a web page having a designated location for a first self-contained advertisement unit, wherein the first self-contained advertisement unit is configured to,
enable user interactions and submission of user interaction data via a submit function, and
be rendered without a plug-in application;
an advertisement unit database element configured to store a plurality of self-contained advertisement units; and
an advertisement unit server element communicatively connected to the client web browser and the advertisement unit database element, the advertisement server element configured to,
receive the user interaction data,
dynamically process the user interaction data to select a second self-contained advertisement unit from the plurality of self-contained advertisements stored in the advertisement unit database element, and
send a second self-contained advertisement unit to the client web browser to replace the first self-contained advertisement unit in the designated location of the web page, wherein the second self-contained advertisement unit is configured to be rendered without a plug-in application.

14. The system for interactive delivery of self-contained advertisement units, as recited in claim 13, wherein the advertisement unit database element and the advertisement unit server element reside in a single computing device.

15. The system for interactive delivery of self-contained advertisement units, as recited in claim 13, wherein the advertisement unit database element and the advertisement unit server element reside in different computing devices.

16. The system for interactive delivery of self-contained advertisement units, as recited in claim 13, wherein the first self-contained advertisement unit is an online query.

17. The system for interactive delivery of self-contained advertisement units, as recited in claim 13, further including,
assigning an audience rating to the first self-contained advertisement unit and the second self-contained advertisement unit.

18. The system for interactive delivery of self-contained advertisement units, as recited in claim 17, wherein the audience ratings of the first self-contained advertisement unit and the second self-contained advertisement unit do not exceed an audience rating level of the web page.

19. The system for interactive delivery of self-contained advertisement units, as recited in claim 13, wherein the first self-contained advertisement unit and the second self-contained advertisement unit are programmed in one of Dynamic Hypertext Markup Language (DHTML) or Cascading Style Sheets (CSS).

20. The system for interactive delivery of self-contained advertisement units, as recited in claim 13, wherein the second self-contained advertisement unit is configured to elicit further interactions with the user.

21. The system for interactive delivery of self-contained advertisement units, as recited in claim 13, wherein the first self-contained advertisement unit and the second self-contained advertisement unit are rendered from code segments that are configured to be portable to other web pages.

22. The system for interactive delivery of self-contained advertisement units, as recited in claim 21, wherein the first self-contained advertisement unit and the second self-contained advertisement unit are web widgets.

23. The system for interactive delivery of self-contained advertisement units, as recited in claim 13, wherein the first self-contained advertisement unit and the second self-contained advertisement unit are configured to receive and execute instructions from each other.

24. The system for interactive delivery of self-contained advertisement units, as recited in claim 23, wherein interactions with and between the first self-contained advertisement unit and the second self-contained advertisement unit are communicated to the advertisement unit server element.

25. The system for interactive delivery of self-contained advertisement units, as recited in claim 24, wherein a third self-contained advertisement unit is selected and sent to the web browser based on the interactions with and between the first self-contained advertisement unit and the second self-contained advertisement unit.
